(19) United States
(12) Patent Application Publication
(10) Pub. No.: US 2025/0208317 A1
(43) Pub. Date: Jun. 26, 2025

(54) ANTIGLARE ARTICLES

(71) Applicant: CORNING INCORPORATED, CORNING, NY (US)

(72) Inventors: Christine Cecala, CORNING, NY (US); Melanie Lian Geiger, Horseheads, NY (US); Yuhui Jin, Painted Post, NY (US); Shenping Li, Painted Post, NY (US); Cameron Robert Nelson, Oak Park, CA (US); Florence Christine Monique Verrier, CORNING, NY (US); Binwei Zhang, Horseheads, NY (US)

(21) Appl. No.: 18/982,025

(22) Filed: Dec. 16, 2024

Related U.S. Application Data
(60) Provisional application No. 63/613,150, filed on Dec. 21, 2023.

(51) Int. Cl. G02B 1/11; G02B 1/14

(52) U.S. Cl. CPC G02B 1/11; G02B 1/14

(57) ABSTRACT

An antiglare article is described herein that includes a substrate including a thickness and a primary surface including a textured region thereon. The the article exhibits, a first-surface absolute specular reflectance of less than or equal to 0.2% at an incident angle 20° from normal, a transmittance haze of less than 35% at an incident angle of 0° from normal, a sparkle of less than 3% at an incident angle of 0° from normal on a 140 PPI device, a distinctness of image of less than 35% at an incident angle of 20° from normal, and a color separation of less than 0.6.

### CLAIM OF PRIORITY

This application claims the benefit of priority under 35 U.S.C. § 119 of U.S. Provisional Application Ser. No. 63/613,150, filed on Dec. 21, 2023, the contents of which is relied upon and incorporated herein by reference in its entirety.

### FIELD

The present specification generally relates to antiglare articles and, in particular, antiglare articles having a textured region with a low first-surface absolute specular reflectance, low haze, low sparkle, low distinctness of image, and low color separation. Display articles are also described herein.

### TECHNICAL BACKGROUND

Transparent, antiglare substrates are often used in display devices such as laptops, light emitting diode (LED) screens, tablets, smartphones, organic light emitted diodes (OLEDs) and touch screens to avoid or reduce specular reflection of ambient light. Conventional approaches to making textured, antiglare substrates have been successful at producing good antiglare properties. However, these textured, antiglare substrates may also exhibit undesireable properties, such as relatively high first-surface absolute specular reflectance, high haze, high sparkle, high distinctness of image, and high color separation.

Accordingly, a continual need exists for textured, antiglare substrates having substrates having low sparkle, distinctness of image, and color separation. This need and other needs are addressed by the present disclosure.

### SUMMARY

Numerous non-limiting aspects are presently presented herein, described as aspects 1-64.

Aspect 1. An antiglare article comprising: a substrate comprising a thickness and a primary surface, the primary surface having on at least a portion thereon a textured region, wherein the antiglare article exhibits: a first-surface absolute specular reflectance of less than or equal to 0.2% at an incident angle 6° from normal; a transmittance haze of less than 35% at an incident angle of 0° from normal; a sparkle of less than 3% at an incident angle of 0° from normal on a 140 PPI device; a distinctness of image of less than 35% at an incident angle of 20° from normal; and a color separation of less than 0.6.

Aspect 2. The antiglare article of aspect 1, wherein the textured region comprises: a low spatial frequency sub-region and a high spatial frequency sub-region substantially superimposed within the low spatial frequency sub-region.

Aspect 3. The antiglare article of aspect 2, wherein the high spatial frequency sub-region comprises an ordered pattern.

Aspect 4. The antiglare article of aspect 2 or aspect 3, wherein the high spatial frequency sub-region comprises concave features.

Aspect 5. The antiglare article of aspect 4, wherein each of the concave features comprises a hexagonal perimeter parallel to a base-plane extending through the substrate disposed below the texture region.

Aspect 6. The antiglare article of any one of aspects 2-5, wherein the high spatial frequency sub-region has a period from 10 micron to 30 micron.

Aspect 7. The antiglare article of any one of aspects 2-6, wherein the high spatial frequency sub-region has a surface roughness (Sₐ) greater than or equal to 100 nm and less than or equal to 400 nm.

Aspect 8. The antiglare article of any one of aspects 2-7, wherein each of the high spatial frequency sub-region has feature sizes from 10 μm to 30 μm.

Aspect 9. The antiglare article of any one of aspects 2-8, wherein the low spatial frequency sub-region comprises a random distribution.

Aspect 10. The antiglare article of any one of aspects 2-9, wherein the low spatial frequency sub-region has a period greater than or equal to 30 μm and less than or equal to 300 μm.

Aspect 11. The antiglare article of any one of aspects 2-10, wherein the low spatial frequency sub-region has a surface roughness greater than or equal to 50 nm and less than or equal to 300 nm.

Aspect 12. The antiglare article of any one of aspects 2-11, wherein the low spatial frequency sub-region has feature sizes from 100 microns to 300 micron.

Aspect 13. The antiglare article of any one of aspects 1-12, wherein the textured region comprises a surface roughness greater than or equal to 200 nm and less than or equal to 500 nm.

Aspect 14. The antiglare article of any one of aspects 1-13, wherein the textured region comprises a peak to valley greater than or equal to 1000 nm and less than or equal to 2000 nm.

Aspect 15. The antiglare article of any one of aspects 1-14, wherein the transmittance haze is greater than or equal to 10% and less than 35%.

Aspect 16. The antiglare article of any one of aspects 1-15, wherein the sparkle is greater than or equal to 1.5% and less than or equal to 3.5% at an incident angle of 0° from normal on a 140 PPI device.

Aspect 17. The antiglare article of any one of aspects 1-16, wherein the distinctness of image is greater than or equal to 0% and less than or equal to 30% at an incident angle of 20° from normal.

Aspect 18. The antiglare article of any one of aspects 1-17, wherein the substrate comprises a glass substrate, a glass-ceramic substrate, or a ceramic substrate.

Aspect 19. The antiglare article of any one of aspects 1-18, wherein the glass substrate, the glass-ceramic substrate, or the ceramic substrate is transparent, colored transparent, opaque, colored opaque, translucent, or colored translucent.

Aspect 20. The antiglare article of any one of aspects 1-19, wherein the substrate comprises composition comprising: greater than or equal to 50 mol % and less than or equal to 70 mol % SiO₂; greater than or equal to 10 mol % and less than or equal to 20 mol % Al₂O₃; greater than or equal to 0 mol % and less than or equal to 2 mol % P₂O₅; greater than or equal to 1 mol % and less than or equal to 6 mol % B₂O₃; greater than or equal to 5 mol % and less than or equal to 10 mol % Li₂O; greater than or equal to 1 mol % and less than or equal to 10 mol % Na₂O; and greater than or equal to 0.01 mol % and less than or equal to 1 mol % K₂O.

Aspect 21. The antiglare article of any one of aspects 1-20, wherein the substrate is an ion-exchanged substrate which comprises a surface compressive stress (CS) greater than or equal to 250 MPa.

Aspect 22. The antiglare article of any one of aspects 1-21, wherein the substrate is an ion-exchanged substrate which comprises a depth of compression (DOC) greater than or equal to 0.1 μm.

Aspect 23. The antiglare article of aspect 22, wherein the ion-exchanged substrate comprises a DOC greater than or equal to 50 μm.

Aspect 24. The antiglare article of any one of aspects 1-23, further comprising an optical coating disposed on the primary surface.

Aspect 25. The antiglare article of aspect 24, wherein the optical coating is a gradient coating.

Aspect 26. The antiglare article of aspect 24, wherein the optical coating is an anti-reflection coating comprising a total reflectance less than 1%.

Aspect 27. The antiglare article of any one of aspects 24-26, wherein the antiglare article including at least the optical coating exhibits a hardness of greater than 8 GPa, as measured by a Berkovich Indenter Hardness test.

Aspect 28. The antiglare article of any one of aspects 24-27, wherein the optical coating has a thickness greater than 200 nm.

Aspect 29. The antiglare article of any one of aspects 1-23, further comprising a surface-modifying layer disposed on the primary surface, wherein the surface-modifying layer is one of an anti-smudge or easy-to-clean coating layer.

Aspect 30. The antiglare article of aspect 29, wherein the surface-modifying layer comprises a fluorine compound or a non-fluorine compound.

Aspect 31 The antiglare article of aspect 29 or aspect 30, wherein the surface-modifying layer has a water contact angle of greater than or equal to 90°.

Aspect 32. The antiglare article of any one of aspects 29-31, further comprising an anti-reflective coating or a gradient coating positioned between the surface-modifying layer and the primary surface.

Aspect 33. A display device comprising the glass article of any one of aspects 1-32, wherein the antiglare article serves as a protective cover for the display device.

Aspect 34. A display article comprising: a substrate comprising a thickness and a primary surface, the primary surface having on at least a portion thereon a textured region, the texture region comprising a high spatial frequency sub-region having a period: period=λ/(Sin [ArcTan(Psp/t)]*n) with an allowable variation of 8 μm or 60%, where t is a thickness of the substrate, n is an average refractive index of the substrate, Psp is a subpixel period, and is a pixel light wavelength.

Aspect 35. The display article of aspect 34, wherein the textured region further comprises a low spatial frequency sub-region substantially superimposed within the high spatial frequency sub-region.

Aspect 36. The display article of aspect 35, wherein the high spatial frequency sub-region comprises an ordered pattern.

Aspect 37. The display article any one of aspects 34-36, wherein the high spatial frequency sub-region comprises concave features.

Aspect 38. The display article of aspect 37, wherein each of the concave features comprises a hexagonal perimeter parallel to a base-plane extending through the substrate disposed below the textured region.

Aspect 39. The display article of any one of aspects 34-38, wherein the high spatial frequency sub-region has a period greater than or equal to 10 μm and less than or equal to 30 μm.

Aspect 40. The display article of any one of aspects 34-39, wherein the high spatial frequency sub-region has a surface roughness greater than or equal to 100 nm and less than or equal to 400 nm.

Aspect 41. The display article of any one of aspects 34-40, wherein each of the high spatial frequency sub-region has feature sizes greater than or equal to 10 μm and less than or equal to 30 μm.

Aspect 42. The display article of any one of aspects 35-41, wherein the low spatial frequency sub-region comprises a random distribution.

Aspect 43. The display article of any one of aspects 35-42, wherein the low spatial frequency sub-region has a period greater than or equal to 30 μm and less than or equal to 300 μm.

Aspect 44. The display article of any one of aspects 35-43, wherein the low spatial frequency sub-region has a surface roughness greater than or equal to 50 nm and less than or equal to 200 nm.

Aspect 45. The display article of any one of aspects 35-44, wherein the low spatial frequency sub-region has feature sizes of greater than or equal to 75 μm and less than or equal to 300 μm.

Aspect 46. The display article of any one of aspects 34-45, wherein the article exhibits: a first-surface absolute specular reflectance of less than or equal to 0.2% at an incident angle 6° from normal; a transmittance haze of less than 35% at an incident angle of 0° from normal; a sparkle of less than 3% at an incident angle of 0° from normal on a 140 PPI device; a distinctness of image of less than 35% at an incident angle of 20° from normal; and a color separation of less than 0.6

Aspect 47. The display article of any one of aspects 34-46, wherein the textured region comprises a surface roughness greater than or equal to 200 nm and less than or equal to 500 nm.

Aspect 48. The display article of any one of aspects 34-47, wherein the textured region comprises a peak to value greater than or equal to 1000 nm and less than or equal to 2000 nm.

Aspect 49. The display article of any one of aspects 34-48, wherein the substrate comprises a glass substrate, a glass-ceramic substrate, or a ceramic substrate.

Aspect 50. The display article of any one of aspects 34-49, wherein the glass substrate, the glass-ceramic substrate, or the ceramic substrate is transparent, colored transparent, opaque, colored opaque, translucent, or colored translucent.

Aspect 51. The display article of any one of aspects 34-50, wherein the substrate comprises composition comprising: greater than or equal to 50 mol % and less than or equal to 70 mol % SiO₂; greater than or equal to 10 mol % and less than or equal to 20 mol % Al₂O₃; greater than or equal to 0 mol % and less than or equal to 2 mol % P₂O₅; greater than or equal to 1 mol % and less than or equal to 6 mol % B₂O₃; greater than or equal to 5 mol % and less than or equal to 10 mol % Li₂O; greater than or equal to 1 mol % and less than or equal to 10 mol % Na₂O; and greater than or equal to 0.01 mol % and less than or equal to 1 mol % K₂O.

Aspect 52. The display article of any one of aspects 34-51, wherein the substrate is an ion-exchanged substrate which comprises a surface compressive stress (CS) greater than or equal to 250 MPa.

Aspect 53. The display article of any one of aspects 34-52, wherein the substrate is an ion-exchanged substrate comprises a depth of compression (DOC) greater than or equal to 0.1t.

Aspect 54. The display article of aspect 53, wherein the ion-exchanged substrate comprises a DOC greater than or equal to 50 μm.

Aspect 55. The display article of any one of aspects 34-54, further composing an optical coating disposed on the primary surface.

Aspect 56. The display article of aspect 55, wherein the optical coating is a gradient coating.

Aspect 57. The display article of aspect 55, wherein the optical coating is an anti-reflection coating comprising a total reflectance less than 1%.

Aspect 58. The display article of aspect 48 or aspect 49, wherein the display article include at least the optical coating exhibits a hardness greater than 8 GPa, as measured by a Berkovich Indenter Hardness test.

Aspect 59. The display article of any one of aspects 55-58, wherein the optical coating has a thickness greater than 200 nm.

Aspect 60. The display article of any one of aspects 34-54, further comprising a surface-modifying layer disposed on the primary surface, wherein the surface-modifying layer is one of an anti-smudge or easy-to-clean coating layer.

Aspect 61. The display article of aspect 60, wherein the surface-modifying layer comprises a fluorine compound or a non-fluorine compound.

Aspect 62 The display article of aspect 60 or aspect 61, wherein the coating has a water contact angle of greater than or equal to 90°.

Aspect 63. The display article of any one of aspects 60-62, further comprising an anti-reflective coating or a gradient positioned between the surface-modifying layer and the primary surface.

Aspect 64. The display article of any one of aspects 34-63, wherein the substrate serves as a protective cover for the display article.

Additional features and advantages of the textured, antiglare articles and methods of forming same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is perspective view of a display article, illustrating a substrate with a textured region disposed over a display;

FIG. 2 is closer-up perspective view of area II of FIG. 1, illustrating the textured region of the substrate of FIG. 1 including primary surface features that are arranged in a hexagonal pattern;

FIG. 3 is an elevation view of a cross-section of the substrate of FIG. 1 taken through line III-III of FIG. 2, illustrating the textured region further including secondary surface features, smaller than the primary surface features, disposed on the textured region including the primary surface features;

FIG. 4 is an overhead view of embodiments of a textured region, illustrating the primary surface features having an elliptical perimeter and projecting from a surrounding portion;

FIG. 5 is another overhead view of embodiments of a textured region, illustrating the primary surface features having a hexagonal perimeter that are arranged hexagonally but separated by a distance (wall-to-wall) and a center-to-center distance;

FIG. 6 is a cross-sectional, schematic view of an article, according to an aspect of the disclosure.

FIG. 7A is a white light interferometer image with a 20× objective of the topography of a low spatial frequency sub-region of an article, according to one or more embodiments described herein;

FIG. 7B is a white light interferometer image with a 50× objective of the topography of the low spatial frequency sub-region of FIG. 1;

FIG. 7C is a white light interferometer image with a 20× objective of the topography of a high spatial frequency sub-region of the article of FIG. 1;

FIG. 7D is a white light interferometer image with a 50× objective of the topography of the high spatial frequency sub-region of FIG. 3;

FIG. 7E is a white light interferometer image with a 20× objective of the topography of a low spatial frequency sub-region of an article, according to one or more embodiments described herein;

FIG. 7F is a white light interferometer image with a 50× objective of the topography of the low spatial frequency sub-region of FIG. 5;

FIG. 7G is a white light interferometer image with a 20× objective of the topography of a high spatial frequency sub-region of the article of FIG. 4;

FIG. 8 is a white light interferometer image with a 50× objective of the topography of the high spatial frequency sub-region of FIG. 7;

FIG. 9 is a power spectral density plot (x-axis: period (in μm); y-axis: Forier Transform magnitude to power of 2 (in μm)) of a low spatial frequency sub-region of an article, according to one or more embodiments described herein;

FIG. 10 is a power spectral density plot (x-axis: period (in μm); y-axis: Forier Transform magnitude to power of 2 (in μm)) of a high spatial frequency sub-region of the article of FIG. 9;

FIG. 11 is a power spectral density plot (x-axis: period (in μm); y-axis: Forier Transform magnitude to power of 2 (in μm)) of a low spatial frequency sub-region of an article, according to one or more embodiments described herein;

FIG. 12 is a power spectral density plot (x-axis: period (in μm); y-axis: Forier Transform magnitude to power of 2 (in μm)) of a high spatial frequency sub-region of the article of FIG. 11;

FIG. 13 are images of comparative and exemplary articles subjected to a fingerprint clenability test, according to one or more embodiments described herein; and

FIG. 14 is an image of an article subjected to an abrasion test, according to one or more embodiments described herein;

FIGS. 15A, 15B, and 15C are schematic views of exemplary coated articles according to aspects described herein;

FIG. 16 depicts a generalized flow chart for a typical process flow of the fabricating a coated article;

FIG. 17 depicts a comparison of “engineered” antiglare surfaces vs. traditional antiglare surfaces;

FIG. 18 schematicly depicts the experimental setup for measuring the reflection color artifacts of an anti-glaring glass surface;

FIG. 19 sechematically depicts minimization of sparkle in some embodiments;

FIG. 20 sechematically depicts processing steps for forming a textured article; and

FIG. 21 schematically depicts an experimental setup for measuring direct contrast ratio.

### DETAILED DESCRIPTION

Reference will now be made in detail to various embodiments of articles that may be textured, antiglare articles, having relatively low sparkle, relatively low distinctness of image (DOI), and relatively low color separation. According to some embodiments, an article includes a substrate including a thickness and a primary surface. The primar surface has on at least a portion thereon a textured region. The article exhibits a first-surface absolute specular reflectance of less than or equal to 0.2% at an incident angle 6° from normal, a transmittance haze of less than 35% at an incident angle of 0° from normal, a sparkle of less than 3% at an incident angle of 0° from normal on a 140 PPI device, a DOI of less than 35% at an incident angle of 20° from normal, and a color separation of less than 0.6.

Substrates transparent to visible light are utilized to cover displays of display articles. Such display articles include smart phones, tablets, televisions, and computer monitors. The displays may be LCDs or OLEDs. The substrate protects the display, while the transparency of the substrate allows the user of the device to view the display.

The substrate reflecting ambient light, especially specular reflection, reduces the ability of the user to view the display through the substrate. Specular reflection in this context is the mirror-like reflection of ambient light off the substrate. For example, the substrate may reflect visible light reflecting off or emitted by an object in the environment around the device. The visible light reflecting off the substrate reduces the contrast of the light from the display transmitting to the eyes of the user through the substrate. As some viewing angles, instead of seeing the visible light that the display emits, the user sees a specularly reflected image. Thus, attempts have been made to reduce specular reflection of visible light off of the substrate.

For example, attempts have been made to reduce specular reflection off of the substrate by texturing the reflecting surface of the substrate. The resulting surface is sometimes referred to as an “antiglare” surface. For example, sandblasting and liquid etching may texture the surface, which generally causes the surface to reflect ambient light diffusely rather than specularly. Diffuse reflection generally means that the surface still reflects the same ambient light, but the texture of the reflecting surface scatters the light upon reflection. The more diffuse reflection interferes less with the ability of the user to see the visible light that the display emits.

Conventional approaches to making textures, antiglare surfaces have been successful at producing surfaces with good antiglare properties (e.g., a first-surface absolute specular reflectance of less than or equal to 0.2% at an incident angle 20° from normal). However, these textured, antiglare substrates may also exhibit undesireable properties, such as relatively high sparkle, DOI, and color separation. Surface treatments aimed at reducing DOI, such as those that form features having a random distribution, may result in undesireably high sparkle. Other surface treatments aimed at reducing sparkle, such as those that form features having an ordered pattern, may result in undesireably high color separation.

Disclosed herein are textured, antiglare articles which mitigate the aforementioned problems. Specifically, the articles disclosed herein comprise a textured region, which results in the article exhibiting a low sparkle (e.g., less than 3% at an incident angle of 0° from normal on a 140 PPI device), DOI (e.g., less than 35% at an incident angle of 20° from normal), and color separation (less than 0.6). For example, the textured region may comprise a high spatial frequency sub-region and a low spatial frequency sub-region substantially superimposed within the high spatial frequency sub-region. The high spatial frequency sub-region imparts a low DOI and color separation. The low spatial frequency sub-region imparts a low sparkle. As such, the presence of high and low spatial frequency sub-regions produces the desireably low sparkle, DOI, and color separation.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “dispose” includes coating, depositing and/or forming a material onto a surface. The disposed material may constitute a layer, as defined herein. The phrase “disposed on” includes the instance of forming a material onto a surface such that the material is in direct contact with the surface and also includes the instance where the material is formed on a surface, with one or more intervening material(s) between the disposed material and the surface. The intervening material(s) may constitute a layer, as defined herein.

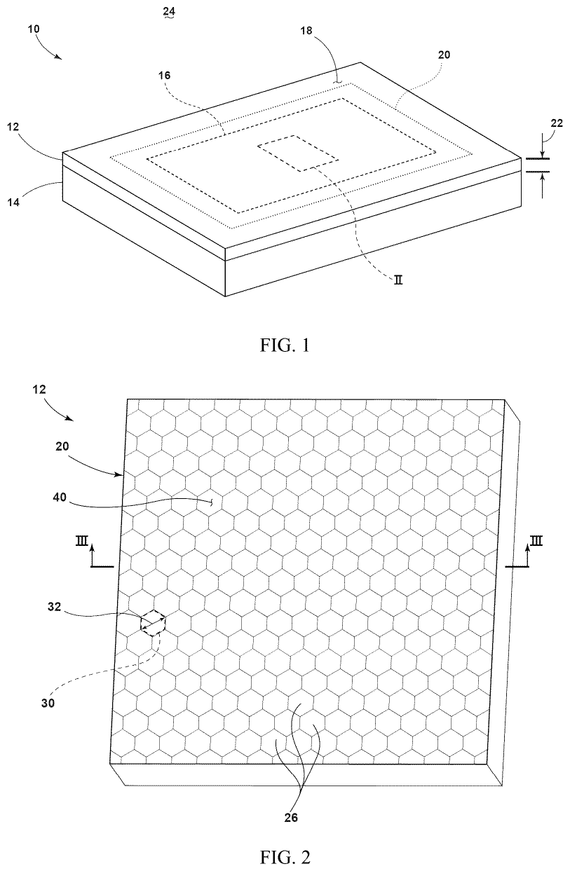

Referring now to FIG. 1, a display article 10 includes a substrate 12. In embodiments, the display article 10 further includes a housing 14 to which the substrate 12 is coupled and a display 16 within the housing 14. In such embodiments, the substrate 12 at least partially covers the display 16 such that light that the display 16 emits transmits through the substrate 12. Some embodiments described herein may be articles that include a substrate 12 and not a housing 14 and/or display 16.

The substrate 12 includes a primary surface 18, a textured region 20 defined on the primary surface 18, and a thickness 22 that the primary surface 18 bounds in part. The primary surface 18 generally faces toward an external environment 24 surrounding the display article 10 and away from the display 16. The display 16 emits visible light that transmits through the thickness 22 of the substrate 12, out the primary surface 18, and into the external environment 24.

Referring now to FIGS. 2-5, in embodiments, the textured region 20 includes primary surface features 26 that define a low spatial frequency region. As described herein with respect to subsequent figures, the textured region 20 may also include a high spatial frequency region, whereby the high spatial frequency sub-region are substantially superimposed within the low spatial frequency sub-region. These sub-regions are defined by geometric features, as described herein, where the geometric features of the high spatial frequency sub-region are more frequent and spaced closer to one another, generally, than the geometric features of the low spatial frequency sub-region. The geometric features may be referred to herein simply as “features” and these features, in some embodiments, may be concave in shape, referred to sometimes as “concave features.” The features defining the low spatial frequency sub-region may be referred to sometimes herein as “primary features,” and the features defining the high spatial frequency sub-region may be referred to sometimes herein as “secondary features.”

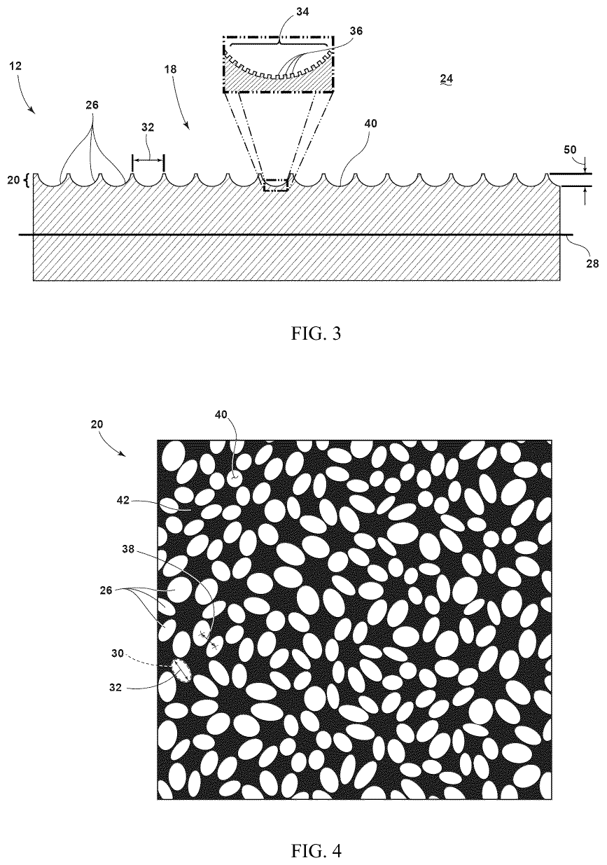

Referring still to FIGS. 2-5, a base-plane 28 extends through the substrate 12 below the textured region 20. The base-plane 28 provides a conceptual reference point and is not a structural feature. Each primary surface feature 26 includes a perimeter 30. The perimeter 30 is parallel to the base-plane 28. The perimeter 30 has a longest dimension 32. For example, in the embodiments illustrated at FIG. 2, the perimeter 30 is hexagonal and thus the longest dimension 32 of the perimeter 30 is the long diagonal of the hexagonal perimeter 30. The longest dimension 32 is parallel to the base-plane 28 as well. The perimeter 30 can be shaped other than hexagonal. In embodiments, the perimeter 30 of each of the primary surface features 26 is polygonal. The primary features may be in an ordered pattern, like in FIG. 2, or a random distribution. In embodiments, the perimeter 30 of each of the primary surface features 26 is elliptical (see, e.g., FIG. 4). In other embodiments, the perimeter 30 of each of the primary surface features 26 is circular. The term “ordered pattern,” as used herein when describing a sub-region, means that the positioning, perimeter, and feature size of each of the features of the sub-region is by design, as opposed to the purely uncontrolled and conincendental place of features via, for example, sandplasting or open etching. In an ordered pattern, the positioning, perimeters, and feature sizes of the features of the sub-region may not be completely uniform, but are within manufacturing tolerances. In addition, the textured region 20 further includes one or more sections 34 (i.e., high spatial frequency sub-regions) that have secondary surface features 36. The secondary surface features 36 may generally be smaller than the primary surface features 26 and/or may be less spread out than the primary surface features 36.

In some embodiments, the positioning, perimeter 30, and longest dimension 32 of each of the primary surface features 26 is by design, as opposed to the purely uncontrolled and coincidental placement of surface features via sandblasting or open etching (i.e., etching without a mask that would define the placement of each surface feature). In embodiments, such as those embodiments illustrated at FIG. 2, the primary surface features 26 form a pattern. In other words, the positioning of a grouping of the primary surface features 26 repeats at the textured region 20. The embodiments illustrated at FIG. 2 are a hexagonal pattern. In embodiments, the longest dimension 32 of each of the primary surface features 26 is about the same or the same within manufacturing tolerances.

In other embodiments, such as those illustrated at FIG. 4, the primary surface features 26 do not form a pattern—that is, the arrangement of the surface features reflect a random distribution. To not form a pattern, the primary surface features 26 can be randomly distributed within certain constraints, such as a center-to-center distance 38 that varies but is greater than a minimum value. In addition, to not form a pattern, the longest dimension 32 of each primary surface feature 26 can be aligned not parallel to each other. A reason to avoid arranging the primary surface features 26 not in a pattern is to avoid the textured region 20 reflecting ambient light with Moiré fringe interference patterns. When the primary surface features 26 form a pattern, a possible consequence is the generation of Moiré fringe interference patterns upon reflection of ambient light.

In one or more embodiments, each of the primary surface features 26 includes a surface 40 facing the external environment 24. The primary surface 18 of the substrate 12 at the textured region 20 includes all of surfaces 40 that the primary surface features 26 provide. In some embodiments, such as those illustrated at FIGS. 3 and 4, the surface 40 of each primary surface feature 26 is concave. In other embodiments, the surface 40 of each primary surface feature 26 is convex. In embodiment, the surfaces 40 of some primary surface features 26 of the textured region 20 are concave, while the surfaces 40 of other primary surface features 26 of the textured region 20 are convex. In additional embodiments, the surface 40 of each primary surface feature 26 of the textured region 20 may be planar and parallel to the base-plane 28.

Now referring to FIG. 6, a textured, antiglare substrate 12 is depicted as including a plurality of primary surfaces 18, and a thickness 22. The substrate 12 also includes a textured region 30a, as defined by the primary surface 18. In some embodiments, the textured region 30a is formed from or otherwise part of the substrate 12, as shown in FIG. 1. In some implementations (not shown), the textured region 30a is defined by the primary surface 18. Further, in some implementations, the textured region 30a is defined by both of primary surfaces 18.

As also depicted in FIG. 6, the textured region 30a of substrate 12 includes a low spatial frequency sub-region 21 and a high spatial frequency sub-region 23. In some embodiments, the high spatial frequency sub-region 23 is superimposed within the low spatial frequency sub-region 21. In other embodiments, the high spatial frequency sub-region 23 overlaps with the low spatial frequency sub-region 21 or stands apart from the low spatial frequency sub-region 21. Referring again to FIG. 6, each of the low spatial frequency sub-region 21 and the high spatial frequency sub-region 23 of the textured region 30a includes a plurality of exposed features. The exposed features of the low spatial frequency sub-region 21 may have an average lateral feature size 31 and an average surface roughness (Rₐ₁). The exposed features of the high spatial frequency sub-region 23 may have an average lateral feature size 32 and an average surface roughness, Rₐ₂. Further, the average surface roughness, Rₐ, of the textured region 30a is a function of the average surface roughness values of the low and high spatial frequency regions 21 and 23, i.e., Rₐ₁ and Rₐ₂, respectively. In some embodiments of the textured, antiglare glass article, the average lateral feature size 31 of the low spatial frequency sub-region 21 exceeds the average lateral feature size 32 of the high spatial frequency sub-region 23. In other embodiments, the average lateral feature size 31 of the low spatial frequency sub-region 21 are about the same or larger than the average lateral feature size 32 of the high spatial frequency sub-region 23. Accordingly, the average lateral feature size 31 can be larger than the average lateral feature size 32 by a factor of 1, 1.5, 2, 2.5, 3, 3.5, 4, 4.5, 5, 6, 7, 8, 9, 10, 15, 20, 30, 40, 50, 60, 70, 80, 90, 100 and all factors between these values.

According to one or more embodiments, the low spatial frequency sub-region, as compared to the high spatial frequency sub-region, may be defined by a period of at least 60 micron. The high spatial frequency sub-region may be defined by a period of less than 60 micron.

According to embodiments, the low spatial frequency sub-region 21 may comprises a random distribution of features. The term “random distribution,” as used herein, refers to a pattern with no long range order (as opposed to a recurring period over a cut-through line in the substrate). In additional embodiments, the features of the low spatial frequency sub-region 21 may be ordered.

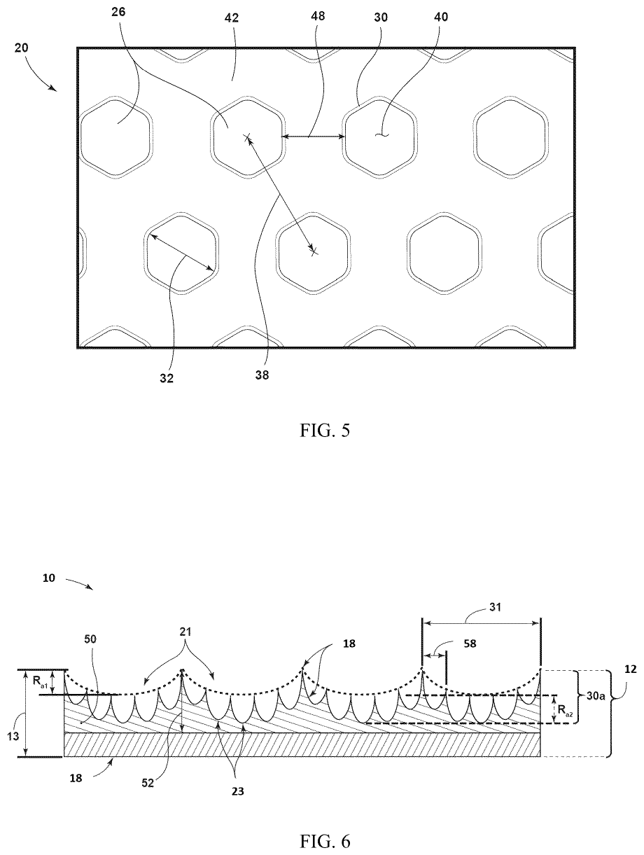

According to embodiments, the low spatial frequency sub-region may have a period greater than or equal to 30 μm and less than or equal to 300 μm (e.g., from 30-50 μm, from 50-100 μm, from 100-150 μm, from 150-200 μm, from 200-300 μm, or any combination of these ranges). As described herein, the period generally refers to the average distance between features, so the period of the high spatial frequency sub-region may be the average distance between primary features. For example, in the embodiment of FIG. 5, the center-to-center distance 38 is equal to the period. Also, for example, in the embodiment of FIG. 6, the average lateral feature size 31 is equal to the period. In embodiments, the the low spatial frequency sub-region may have feature sizes from 75 μm to 300 (e.g., from 75-100 μm, from 100-150 μm, from 150-200 μm, from 200-300 μm, or any combination of these ranges). In general, the feature size refers to the longest dimension of each surface feature. For example, in the embodiment of FIG. 6, the feature size of the high spatial frequency sub-region is equal to the longest dimension 32.

According to embodiments, the high spatial frequency sub-region may have a period from 10 μm to 30 μm (such as, e.g., from 10-15 μm, from 15-20 μm, from 20-25 μm, from 25-30 μm, or any combination of these ranges). For example, in the embodiment of FIG. 6, the average lateral feature size 58 is equal to the period. In embodiments, the the high spatial frequency sub-region may have feature sizes greater than or equal to 10 μm and less that 30 μm (such as, e.g., from 10-15 μm, from 15-20 μm, from 20-25 μm, from 25-30 μm, or any combination of these ranges). In general, the feature size refers to the longest dimension of each surface feature. For example, in the embodiment of FIG. 6, the average lateral feature size 58 is also equal to the period since there is no space between features in the high spatial frequency sub-region.

The high spatial frequency sub-region and/or low spatial frequency sub-region features may also define a peak to valley measurement, greater than or equal to 1000 nm and less than or equal to 2000 nm. As described herein, peak to valley refers to the distance sometimes referred to as Pz as measured under ISO 21920, which generally measures the height from the lowest to highest point on a surface profile.

As described, the low spatial frequency sub-region may impart a roughness which may be form 50 nm to 500 nm. For example, the low spatial frequency sub-region has a surface roughness from 50-100 nm, from 100-200 nm, from 200-300 nm, from 300-400 nm, from 400-500 nm, or any combination of these ranges. The roughness imparted from the high spatial frequency sub-region is calculated as the Sₐ, which may be from 100 nm to 400 nm, such as from 100-150 nm, from 150-200 nm, from 200-250 nm, from 250-300 nm, from 300-350 nm, or from 350-400 nm. As used herein, surface roughness (Sₐ) of the high spatial frequency sub-region is determined according to ISO 25178 on the high frequency sub-region after a filter has been applied (a 60 micron Gaussian filter per ISO 16610-61). As is know by those skilled in the art, the Sₐ can generally be determined as:

$$Sa = \frac{1}{A} {\int }_{A} \vert z ( x , y ) \vert dxdy$$

According to other embodiments, a display article includes a substrate including a thickness and a primary surface. the primary surface having on at least a portion thereon a textured region, the texture region comprising a high spatial frequency sub-region having a period:

$$period = λ / ( Sin [ Arc Tan ( Psp / t ) ] * n )$$

with an allowable variation of 8 μm or 60%, where t is a thickness of the substrate, n is an average refractive index of the substrate, Psp is a subpixel period, and λ is a pixel light wavelength.

According to some embodiments, the high frequency, mostly ordered texture is used to reduce the sparkle (PPD) of the low frequency, random texture. At the same time, the low frequency texture mitigates color break-up effects from the high frequency texture and lowers the DOI. The high frequency texture lowers the PPD by creating replicated images of the display subpixels through diffraction. If the amplitude and period of the high frequency texture is tuned appropriately, the replicated subpixel images will have the same lateral dimensions and brightness as the subpixel. In some cases, the entire pixel can appear to be illuminated even though only a single subpixel (e.g. green) is switched on. A completely illuminated pixel will in general have a lower PPD compared to a partially illuminated pixel. Without being bound by theory, it is believed that the grating period for minimizing PPD as a function of pixel pitch Psp and total device thickness t is given by inverting the expression period=λ/(n_{stack}*Sin(ArcTan(pₛₚ/t)). As an example, for a device with a thickness of 1600 microns, pixel spacing of 40 microns, and an average refractive index of 1.5, the approximate optimized surface period is 14.5 microns, according to some embodiments. Such embodiments may minimize spacle. FIG. 19 schematically depicts the phenomena described herein, showing the pixel replication effect on a 1-D display. The ordered features create diffracted replicates of the sub-pixel, which produce ‘ghost images’ on either side of the sub-pixel. This gives the perception of a completely illuminated pixel to an observer, resulting in lower PPD. The PPD is minimized when the diffraction angle θ_{D} is equal to the angle subtended by the subpixel Op.

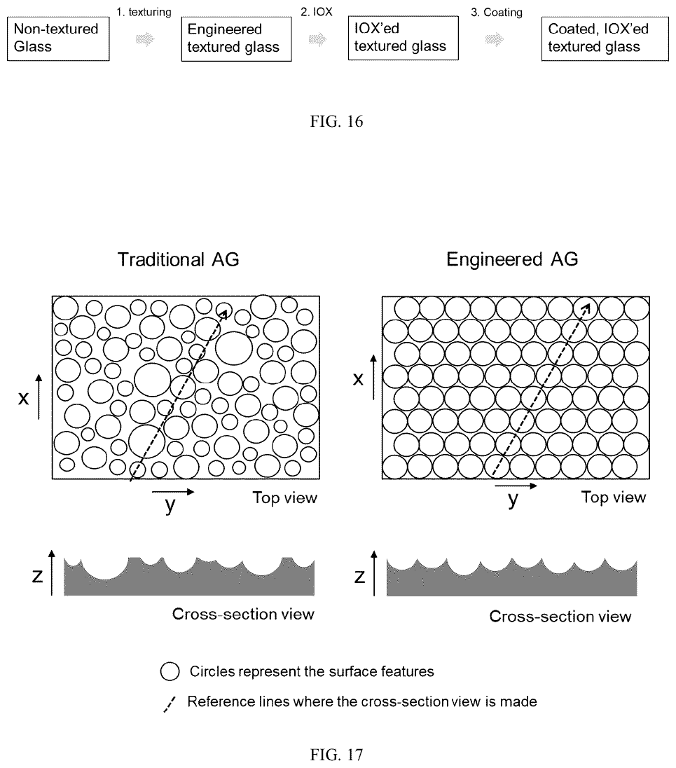

FIG. 16 depicts a generalized process by which an antiglare article may be produced. According to embodiments, a non-textured glass may be provided. In other embodiments, the non-textured glass may be substituted for a glass-ceramic or ceramic substrate. The non-textured glass may undergo texturing, as described herein. Following texturing, which forms an engineered textured substrate, the engineered textured substrate may be ion exchanged, embodiments of which are described in detail herein. After ion-exchange, a coating (such as an optical coating) may be applied over the textured surface, embodiments of which are described in detail herein.

The textured articles described herein may be formed by a variety of techniques, including photolithography and/or acid or basic etching. Also contemplated is laser etching. Without limitation, suitable techniques for fabricating the articles described herein are disclosed in U.S. patent application Ser. No. 14/563,228, filed Dec. 8, 2014; U.S. patent application Ser. No. 17/370,328, filed Jul. 8, 2021; U.S. patent application Ser. No. 17/369,301, filed Jul. 7, 2021; U.S. patent application Ser. No. 17/852,467, filed Jun. 29, 2022; and U.S. patent application Ser. No. 17/369,315, filed Jul. 7, 2021, the entirety of all of which are incorporated by reference in their entireties.

FIG. 17 depicts an “engineered” antiglare substrate that may be prepared by lithographic methods described herein. In general, the engineered antiglare substrates may have features that are ordered and/or about the same size. This is different in constract to the textured surface made from the traditional textured processes (such as in situ masking and etching, and sandblast & etch). The engineered surface may possess at least one of the following characteristics: (1) the features size distribution may not necessarily follow the typical normal distribution. For example, it can be a descrete size distribution; it can be very extreme narrow distribution with less than 5% to 10% size variation; (2) the feature location and arrangement may align in certain order at least in one of the dimensions (x and y direction in parallel to the glass surface) (for example, the features are aligned in the x-y plain as the hexagonal pattern or slightly mismatched hexagonal pattern); (3) the features may be aligned with similar peak to valley depth of the each features, where the feature height or depth distribution may not necessarily follow the normal distribution—it can be a descrete distribution, or it can be a combination of high frequency and low frequency features of multiple levels.

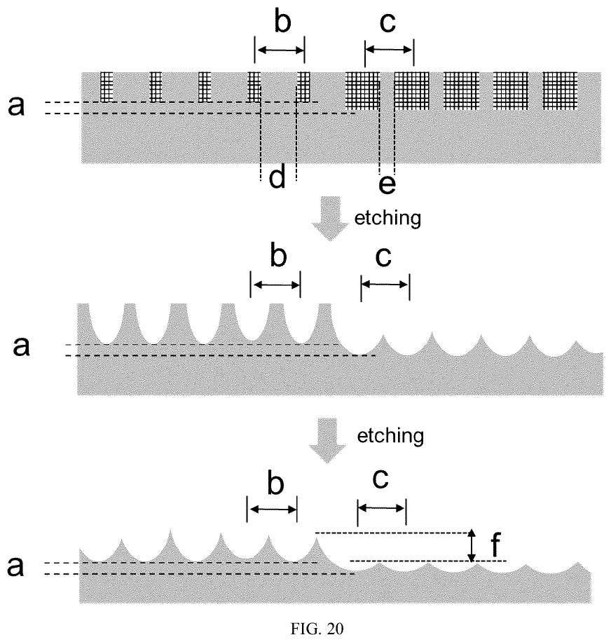

According to embodiments, the engineered textured glass surface can be made from the photolithography & etch process, or a laser glass texturing process. FIG. 20 depicts a typical photolithography & etch process to create the engineered textured surface with controllable feature size, peak height and valley depth. As shown in FIG. 20, a dual texture surface morphology using photomask pinholes with two opening sizes is depicted. The top schematic shows a dual-texture surface that can be produced with photomask pinholes of varying sizes. The pinhole sizes are given by |b-d| on the left side of the surface and |c-e| on the right side. The depth of the regions represents potential variations in the starting seed depths that can be generated by an additional mask-and-etch step. Such a variation would result in a change in the depths of the bottoms of the cuspy features, given by |a|. The middle and bottom schematics represent the resulting surface after etching for short and long times, respectively. The typical photolithography and etch process may include photomasking, light etch to create the etch seeds, mask removal, and additional etch to create the final texture.

The articles disclosed herein, such as the substrate 12 of FIG. 1, may exhibit multiple optical properties, such as specular reflectance, transmittance haze, sparkle, distinctness of image, and/or color separation. The optical properties are described herein.

According to one or more embodiments, the article may exhibit a first-surface absolute specular reflectance of less than or equal to 0.2% at an incident angle 6° from normal. As described herein, the specular reflectance refers to the absolute specular reflectance of light from smooth solid materials that is measured at near normal incidence (6°), which may be measured using an Agilent Cary spectrometer, or similar device, with the VW Absolute Specular Reflectance Accessory. “VW” describes the light path through the accessory in the reference and measurement positions. The design features a kinematically mounted spherical mirror, which is used for both calibration and sample measurement. With the exception of the sample, the same optical elements are always in the light path, providing a truly absolute reflectance measurement. Absolute measurements remove any need to correct results against standard reference materials. For example, the article may exhibit a first-surface absolute specular reflectance of less than or equal to 0.18, less than or equal to 0.16, less than or equal to 0.14, less than or equal to 0.12, less than or equal to 0.1, less than or equal to 0.08, less than or equal to 0.06, less than or equal to 0.04, or even less than or equal to 0.02, at an incident angle 6° from normal

According to one or more embodiments, the article may exhibit a transmittance haze of less than 35% at an incident angle of 0° from normal. The the relatively low haze may provide desirable optical properties and a pleasing aesthetic appearance. “Transmission haze” (also referred to as “haze”) is a surface light scatter characteristic and refers to the percentage of light scattered outside an angular cone of 4.0° in accordance with ASTM procedure D1003. For an optically smooth surface, transmission haze is generally close to zero. Low haze can be desirable for applications requiring high display contrast, while high haze can be useful for optical designs having scattering, such as edge illumination, or for aesthetic reasons, such as reducing the “black hole” appearance of the display in the off state. The general preference for low versus high haze (and the acceptance of performance trade-offs) can be motivated by customer or end-user preferences, and their final application and use mode. For example, the haze provides an antiglare capability that improves performance in high ambient light conditions, such as bright sunlight. In one or more embodiments, the haze may be from 10% to 35%, such as at least 10% and less than or equal to 30%, less than or equal to 25%, less than or equal to 20%, or less than or equal to 15%.

According to one or more embodiments, the article may exhibit a sparkle of less than 3% at an incident angle of 0° from normal on a 140 PPI device. In one or more embodiments, the article may have a sparkle at 140 ppi of from 1.5% to 3.5%, such as from 1.5% to 2%, from 2% to 2.5%, from 2.5% to 3%, from 3% to 3.5%, or any combination of these ranges. Display “sparkle” (or PPD) is a phenomenon that can occur when antiglare or light-scattering surfaces are incorporated into a display system. Sparkle is associated with a very fine grainy appearance that can appear to have a shift in the pattern of the grains with changing viewing angle of the display. This type of sparkle is observed when pixelated displays such as LCDs are viewed through an antiglare surface. Such sparkle is of a different type and origin from “sparkle” or “speckle” that has been observed and characterized in projection or laser systems. Unless otherwise specified, sparkle is measured using a SMS-1000 (Display-Messtechnik & Systeme) and a display arrangement that includes an edge-lit liquid crystal display screen (twisted nematic liquid crystal display) having a sub-pixel pitch of 60 μm by 180 μm and pixel pitch of 180 μm (i.e., a resolution of 140 pixels-per-inch (ppi)) and a 1 mm thick stack of glass between the pixel layer within the display stack and the substrate to be tested. To determine sparkle of a display system or an antiglare surface that forms a portion of a display system, a screen is placed in the focal region of an “eye-simulator” camera (of the SMS-1000), which approximates the parameters of the eye of a human observer. As such, the camera system includes an aperture (or “pupil aperture”) that is inserted into the optical path to adjust the collection angle of light, and thus approximate the aperture of the pupil of the human eye. In the sparkle measurements described herein, the iris diaphragm is set to the full angle of the device, which subtends an angle of at least 20 milliradians. A sparkle measurement is performed by (1) focusing the camera and lens assembly on the display pixels, (2) collecting an image of the textured sample on the display, (3) translating the sample, (4) collecting a second image of the textured sample in that new region, and (5) calculating the sparkle. The sparkle calculation involves taking the difference between the two images, applying a spatial filter, and calculating the standard deviation (or noise) in the resulting image. Filtering is used to account for the limited angular resolution of the human eye and to separate the display pixel modulation from the sparkle generated by the AG surface. This measurement conforms to IEC 62977-3-9:2023 Electronic displays—Part 3-9: Evaluation of optical performance—Display sparkle contrast.

According to one or more embodiments, the article may exhibit a distinctness of image of less than 35% at an incident angle of 20° from normal. “Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular, DOI is calculated according to equation (1):

$$DOI = [ 1 - \frac{{R}_{O S}}{{R}_{S}} ] \times 100 \qquad ( 1 )$$

where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of ±0.05° centered on the specular direction. Both Rs and Ros were measured using a goniophotometer (Rhopoint Instruments) that is calibrated to a certified black glass standard, as specified in ASTM procedures D523 and D5767. The goniophotometer uses a detector array in which the specular angle is centered about the highest value in the detector array. DOI can also be evaluated using 1-side (black absorber coupled to rear of glass) method. The 1-side measurement allows the gloss, reflectance, and DOI to be determined for a single surface (e.g., a single roughened surface) of the glass article. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767. The scale value obtained with the measuring procedures of ASTM D5767 range from 0 to 100 with a value of 100 representing perfect DOI (image clarity). In one or more embodiments, the article may exhibit a distinctness-of-image of less than 60%. In one or more embodiments, the articles exhibit a distinctness-of-image of less than 30%, less than 25%, less than 20%, less than 15%, less than 10%, or even less than 5%, and greater than or equal to 0%.

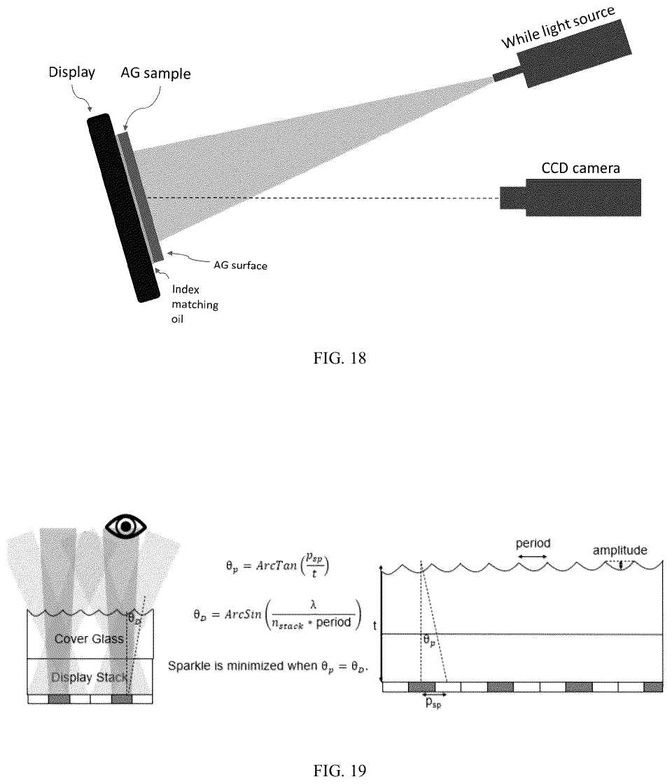

According to one or more embodiments, the article may exhibit a color separation of less than 0.6, such as less than 0.5, less than 0.4, less than 0.3, less than 0.2, or even less than 0.1. To measure color separation, a testing methods described herein is utilized. A white light source is used to illuminate the sample under test (e.g., glass with textured surface). The sample is set on the front surface of a display (such as a cell phone, TV, or a laptop) with textured surface facing to the light source. The experimental setup is generally depicted in FIG. 18. Oil with refractive index matching the textured glass is used between the sample and the display.

The display is switched-off during color separation measurement. The scattered light pattern reflected from surface is captured by a color CCD camera. Then, the captured color image of scattered light pattern is digitally processed, and chromaticity coefficients (Cx and Cy) along a selected line are calculated. The color shifts of ΔCx and ΔCy (which are defined by the difference between maximum and minimum of Cx or Cy) along the selected line are obtained. Because the visibility of color change seen by human eyes is not only relative to the color shifts: ΔCx and ΔCy, but also the distance (or angle separation) between the locations of maximum and minimum of Cx (or Cy). To consider this effect, the color separation parameter may be measured describing the spatial color separation, which is defined as:

$$Δ {C}_{x \_ c} = \frac{d {θ}_{r}}{d {θ}_{x}} Δ {C}_{x}$$

$$Δ {C}_{y \_ c} = \frac{d {θ}_{r}}{d {θ}_{y}} Δ {C}_{y}$$

where dθᵣ=0.84 degree is refereed angle separation, dθₓ and dθ_{y} are the angle separations in degree between the locations of maximum and minimum of Cx and Cy, respectively.

In one or more embodiments, the substrate may comprise a glass substrate, a glass-ceramic substrate, or a ceramic substrate. The substrate can be formed from a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li2O-Al2O3-SiO2 system (i.e., LAS-System) glass-ceramics, MgO-Al2O3-SiO2 system (i.e., MAS-System) glass-ceramics, ZnO×Al2O3× nSiO2 (i.e., ZAS system), and/or glass-ceramics that include a predominant crystal phase including β-quartz solid solution, β-spodumene, cordierite, and lithium disilicate. In an exemplary embodiment, the textured glass-based substrate 110 includes any one of the glass-ceramic compositions disclosed in U.S. Patent Application Publication No 2016/0102010 A1, filed on Oct. 8, 2015, which is incorporated by reference in its entirety. The glass-ceramic substrates may be strengthened using a chemical strengthening process.

In one or more embodiments, the substrates may include an alkali aluminosilicate glass, such as a lithium aluminosilicate glass. Exemplary lithium aluminosilicate glass materials are those described in U.S. Patent App. Pub. No. 2019/0300422 A1, titled “Glasses Having High Fracture Toughness,” published Oct. 3, 2019, the contents of which are incorporated herein by reference in their entirety. In additional embodiments, alkaline earth aluminosilicate glass may be utilized.

In some embodiments, the substrate may comprise a composition comprising: greater than or equal to 50 mol % and less than or equal to 70 mol % SiO₂, greater than or equal to 10 mol % and less than or equal to 20 mol % Al₂O₃,
greater than or equal to 0 mol % and less than or equal to 2 mol % P₂O₅, greater than or equal to 1 mol % and less than or equal to 6 mol % B₂O₃, greater than or equal to 5 mol % and less than or equal to 10 mol % Li₂O, greater than or equal to 1 mol % and less than or equal to 10 mol % Na₂O, and greater than or equal to 0.01 mol % and less than or equal to 1 mol % K₂O. Additional compositional embodiments are disclosed in U.S. Pat. No. 18,527,526, filed Dec. 4, 2023, the entirety of which is incorporated by reference herein.

In one or more embodiments, the substrates may include an alkali aluminosilicate that is substantially free or free of lithium. Exemplary alkali aluminosilicate glass materials that are substantially-free or free of lithium are those described in U.S. Patent App. Pub. No. 2009/0142568 A1, titled “Glasses Having Improved Toughness and Scratch Resistance,” published Jun. 4, 2009, U.S. Patent App. Pub. No. 2009/0142568 A1, titled “Glasses Having Improved Toughness and Scratch Resistance,” published Jun. 4, 2009; U.S. Patent App. Pub. No. 2014/0227523 A1, titled “Zircon Compatible, Ion Exchangeable Glass With High Damage Resistance,” published Aug. 14, 2014; and U.S. Patent App. Pub. No. 2011/0201490 A1, titled “Crack And Scratch Resistant Glass And Enclosures Made Therefrom,” published Aug. 18, 2011, the contents of each of which are incorporated herein by reference in their entirety.

In some aspects, the substrate, in addition to being transparent, can also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, brown etc.

According to some embodiments, the substrate 12 can possess an ion-exchangeable glass composition that is strengthened by either chemical or thermal means that are known in the art. In one embodiment, the glass substrate is chemically strengthened by ion exchange. In this process, metal ions at or near a primary surface 18 and/or primary surface 18 of the glass substrate 12 are exchanged for larger metal ions having the same valence as the metal ions in the glass substrate. The exchange is generally carried out by contacting the glass substrate 12 with an ion exchange medium such as, for example, a molten salt bath that contains the larger metal ion. The metal ions are typically monovalent metal ions such as, for example, alkali metal ions. In one non-limiting example, chemical strengthening of a glass substrate 12 that contains sodium ions by ion exchange is accomplished by immersing the glass substrate 12 in an ion exchange bath comprising a molten potassium salt such as potassium nitrate (KNO₃) or the like. In one particular embodiment, the ions in the surface layer of the glass substrate 12 and the larger ions are monovalent alkali metal cations, such as Li⁺ (when present in the glass), Na⁺, K⁺, Rb⁺, and Cs⁺. Alternatively, monovalent cations in the surface layer of the glass substrate 12 may be replaced with monovalent cations other than alkali metal cations, such as Ag⁺ or the like.

In these embodiments of the textured, antiglare glass article 100 depicted in FIG. 6, the replacement of small metal ions by larger metal ions in the ion exchange process creates a compressive stress region 50 in the glass substrate 12 that extends from the primary surface 18 to a depth 52 (referred to as the “depth of layer”) that is under compressive stress. It should also be understood that a compressive stress region can be formed in the glass substrate that extends from the primary surface 14 to a depth (not shown in FIG. 1) that is comparable in nature to the compressive stress region 50. More particularly, this compressive stress at the primary surface of the glass substrate is balanced by a tensile stress (also referred to as “central tension”) within the interior of the glass substrate. In some embodiments, the primary surface 18 of the glass substrate 12 described herein, when strengthened by ion exchange, has a compressive stress of at least 350 MPa, and the region under compressive stress extends to a depth 52, i.e., depth of layer, of at least 15 pan below the primary surface 18.

Ion exchange processes are typically carried out by immersing the glass substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 1.6 hours. However, temperatures and immersion times different from those described above may also be used. Such ion exchange treatments, when employed with a glass substrate 12 having an alkali aluminosilicate glass composition, result in a compressive stress region 50 having a depth 52 (depth of compression) of at least about 0.1 μm, e.g., ranging from about 10 μm up to at least 50 μm with a compressive stress ranging from about 250 MPa up to about 800 MPa, and a central tension of less than about 100 MPa.

A typical ion exchange process may include a glass sheet of 0.55 mm, such as the glass compositions described herein, being subjected to a first ion-exchange with 50 wt % KNO₃, 50 wt % NaNO₃, 0.5 wt % silicic acid, at 400° C. for 270 min, followed by a second ion-exchange with 99 wt % KNO₃, 1 wt % NaNO₃, 0.5 wt % silicic acid, at 390° C. for 15 min, forming a compressing stress of at least 700 MPa and a DOC of at least 70 micron.

In one or more embodiments, the article 10 may further include an optical coating disposed over the primary surface 18. In general, an optical coating may enhance the optical characteristics of the article 10, such as supplying anti-reflective properties. Without limitation, contemplated optical coatings include those disclosed in U.S. patent application Ser. No. 18/528,916, filed Dec. 5, 2023, the entirety of which is incorporated by reference herein. Exemplary optical coatings that can be disposed on the textured substrate 12 are discussed below with respect to FIGS. 15A-15C.

In aspects, as shown in FIGS. 15A-15C, the coated article 201, 211, or 221 (similar or identical to the substrate 12 of other figures) can comprise an optical stack 203 comprising a third major surface 205 disposed on the first major surface 105 of the substrate 103. As shown, the optical stack 203 can comprise a fourth major surface 207 opposite the third major surface 205 with a stack thickness 209 defined therebetween. In aspects, the stack thickness 209 can be about 10 nanometers (nm) or more, about 50 nm or more, about 100 nm or more, about 300 nm or more, about 500 nm or more, about 700 nm or more, about 1 μm or more, about 10 μm or less, about 5 μm or less, about 2 μm or less, or about 1 μm or less. aspects, the stack thickness 209 can range from about 10 nm to about 10 μm, from about 50 nm to about 5 μm, from about 100 nm to about 2 μm, from about 300 nm to about 1 μm, from about 500 nm to about 1 μm, or any range or subrange therebetween. In exemplary aspects, the stack thickness 209 can range from 10 nm to 10 μm, from 50 nm to 5 μm, or from 50 nm to 500 nm.

In further aspects, the optical stack 203 can comprise an anti-reflective (AR) coating, a band-pass filter coating, an edge neutral mirror, a beam splitter coating, a multi-layer high-reflectance coating, and/or an edge filter coating. For example, the anti-reflective coating of the optical stack 203 can be positioned between the surface-modifying layer (e.g., anti-fingerprint coating 113) and the substrate 103. In even further aspects, the optical stack 203 (e.g., anti-reflective coating) can comprise two or more layers with differing refractive index values, for example, with a first low refractive index (RI) from about 1.3 to about 1.6 and a second high refractive index (RI) from about 1.6 to about 3.0. In still further aspects, the two or more layers of the optical stack 203 can form an alternative set of layers, for example, 2 sets or more, 3 sets or more, 5 sets or more, or 10 sets or more, for example, from 2 to 15 periods, from 2 to 10 periods, from 2 to 12 periods, from 3 to 8 periods, from 3 to 6 periods, or any range or subrange therebetween.

In aspects, as shown in FIG. 15B, the coated article 211 comprises optical stack 203a comprising a plurality of a silicon-containing oxide, a silicon-containing nitride, and/or a silicon-containing oxynitride layers. For example, the optical stack 203a can be an anti-reflective coating. As shown, the optical stack 203a can comprise one or more periods 213 comprising two or more layers with different refractive indices, for example, a first low RI layer 215a and a second high RI layer 217a. For example, the optical stack 203a shown in FIG. 15B has 2 periods 213 comprising first low RI layers 215a and 215b (L) and a second high RI layers 217a and 217b (H) that alternate in the following sequence of layers: L/H/L/H, although H/L/H/L could be provided in other aspects. An absolute value of a difference between the first low RI layer 215a and a second high RI layer 217a can be about 0.01 or more, about 0.05 or more, about 0.1 or more, or even 0.2 or more. Exemplary materials for the first low RI layer 215a include SiO₂, Al₂O₃, GeO₂, SiO₂, AlOₓN_{y}, SiOₓN_{y}, SiᵤAlᵥOₓN_{y}, MgO, and MgAl₂O₄. Exemplary materials for the second high RI layer 217a include SiᵤAlᵥOₓN_{y}, AlN, oxygen-doped SiNₓ, SiNₓ, Si₃N₄, AlOₓN_{y}, SiOₓN_{y}, Ta₂O₅, Nb₂O₅, HfO₂, TiO₂, ZrO₂, Y₂O₃, ZrO₂, Al₂O₃, and diamond-like carbon. The oxygen content of the materials for the high RI layer(s) 130B may be minimized, especially in SiNₓ or AlNₓ materials. The foregoing materials may be hydrogenated up to about 30% by weight. As used herein, it is to be understood that the subscripts (e.g., “u,” “v”, “x,” “y,” and “z”) range from greater than 0 to 1, where the subscripts sum to 1 to represent an “atomic fraction formula.” See, for example: (i) Charles Kittel, Introduction to Solid State Physics, seventh edition, John Wiley & Sons, Inc., NY, 1996, pp. 611-627; (ii) Smart and Moore, Solid State Chemistry, An introduction, Chapman & Hall University and Professional Division, London, 1992, pp. 136-151; and (iii) James F. Shackelford, Introduction to Materials Science for Engineers, Sixth Edition, Pearson Prentice Hall, New Jersey, 2005, pp. 404-418. The balance of the material (i.e., 1 minus the sum of the subscripts) is the first atom (e.g., SiNₓ with x=0.57 actually corresponds to Si_{0.43}N_{0.57}, which is the same as Si₃N₄). Also, the sum of all subscripts is greater than 0.

In aspects, the optical stack 203a can include the antireflective structure, antireflective coating, or outer optical film described in U.S. Pat. No. 10,948,629, issued Mar. 16, 2021, U.S. Published Application No. 2022/0011468, and/or WIPO Publication WO 2022/125846, which are incorporated by reference in their entirety. In aspects, as shown in FIG. 15B, the optical stack 203a can comprise a capping layer 219. In further aspects, the capping layer 219 can comprise a low refractive index material, which can be the same material as the first low RI layer 215a. In further aspects, the capping layer 219 can comprise a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). An exemplary aspect of the capping layer is silicon dioxide (SiO₂). In aspects, as shown, the layer of the optical stack 203 closest to the substrate 103 can be a low index layer (i.e., first low RI layer 215a) and the layer closest to the surface-modifying layer (e.g., anti-fingerprint coating 113) can be a low index layer (e.g., capping layer 219). An exemplary combination of materials for the optical stack is SiO₂ for the first low RI layer, silicon nitride (e.g., Si₃N₄, SiNₓ) or silicon oxynitride (SiOₓN_{y}) for the second high RI layer, and silicon dioxide (SiO₂) for the capping layer.

In aspects, the coated article 211 can comprise a stack thickness 209a corresponding to a physical thickness of the optical stack 203a in a range from about 50 nm to less than 500 nm, from about 75 nm to about 490 nm, from about 100 nm to about 180 nm, from about 125 nm to about 475 nm, from about 150 nm to about 450 nm, from about 175 nm to about 425 nm, from about 200 nm to about 400 nm, from about 225 nm to about 375 nm, from about 250 nm to about 350 nm, from about 250 nm to about 340 nm, or any range or subrange therebetween. As used herein, the term “optical thickness” is determined by (n*d), where “n” refers to the RI of the sub-layer and “d” refers to the physical thickness of the layer. In aspects, at least one layer in the optical stack 203a can have an optical thickness from about 2 nm to about 200 nm, from about 10 nm to about 100 nm, from about 15 nm to about 90 nm, from about 50 nm to about 80 nm, or any range or subrange therebetween. In further aspects, the first low RI layers 215a and 215b in periods 213 in the optical stack 203 can be within or more of the ranges mentioned in the previous sentence. In aspects, a combined physical thickness of the second high RI layers 217a and 217b can be about 90 nm or more, about 100 nm or more, about 120 nm or more, about 130 nm or more, about 150 nm or more, or less than 500 nm. For example, the combined physical thickness of the second high RI layers 217a and 217b can range from about 90 nm to less than 500 nm, from about 100 nm to about 300 nm, from about 120 nm to about 200 nm, or any range or subrange therebetween. In aspects, the combined physical thickness of the second high RI layers 217a and 217b as a percentage of the physical thickness of the stack thickness 209a can be about 30% or more, about 35% or more, about 40% or more, or about 45% or more, for example, ranging from about 35% to about 75%, from about 40% to about 65%, from about 45% to about 55%, or any range or subrange therebetween.

In aspects, the optical stack 203a of the coated article 211 can comprise a residual stress of less than about +50 MPa (tensile) to about −1000 MPa (compression). In some implementations of the article 100, the anti-reflective coating is characterized by a residual stress from about −50 MPa to about −1000 MPa (compression), or from about −75 MPa to about −800 MPa (compression). Unless otherwise noted, residual stress in the anti-reflective coating is obtained by measuring the curvature of the substrate 103 before and after deposition of the anti-reflective coating, and then calculating residual film stress according to the Stoney equation according to principles known and understood by those with ordinary skill in the field of the disclosure.

In aspects, the optical stack 203a and/or the coated article 211 may exhibit a visible photopic average reflectance of about 1% or less, about 0.9% or less, about 0.8% or less, about 0.7% or less, about 0.6% or less, about 0.5% or less, about 0.4% or less, about 0.3% or less, or about 0.2% or less, over the optical wavelength regime. These photopic average reflectance values may be exhibited at incident illumination angles in the range from about 0° to about 20°, from about 0° to about 40°, or from about 0° to about 60°. As used herein, “photopic average reflectance” mimics the response of the human eye by weighting the reflectance versus wavelength spectrum according to the human eye's sensitivity. Photopic average reflectance may also be referred to as the luminance, or tristimulus Y value of reflected light, according to known conventions, for example CIE color space conventions. The photopic average reflectance (Rₚ) is defined as the spectral reflectance, R(λ), multiplied by the illuminant spectrum, I(λ), and the CIE's color matching function, y̅(λ), related to the eye's spectral response:

$$( {R}_{p} ) = {\int }_{380 nm}^{720 nm} R ( λ ) \times I ( λ ) \times \overline{y} ( λ ) d λ .$$

Further, the article exhibits a CIE a* value, in reflectance, from about −10 to +2 and a CIE b* value, in reflectance, from −10 to +2, the CIE a* and CIE b* values each measured on the optical film structure at a normal incident illumination angle. In aspects, the optical stack 203a and/or the coated article 211 can exhibit a photopic average light transmission of about 90% or greater, 92% or greater, 94% or greater, 96% or greater, or 98% or greater, over the optical wavelength regime. In some embodiments, the optical stack 203a and/or the coated article 211 exhibits an average light transmission of about 87% or greater, 88% or greater, 89% or greater, 90% or greater, 91% or greater, 92% or greater, 93% or greater, 94% or greater, or 95% or greater, over the optical wavelength regime in the infrared spectrum from 800 nm to 1000 nm, from 900 nm to 1000 nm, or from 930 nm to 950 nm. In aspects, the optical stack 203a and/or the coated article 211 can exhibit a hardness of 8 GPa or greater measured at an indentation depth of about 100 nm or a maximum hardness of 9 GPa or greater measured over an indentation depth range from about 100 nm to about 500 nm, the hardness and the maximum hardness measured by a Berkovich Indenter Hardness Test (as defined below).

In aspects, as shown in FIG. 15B, the coated article 211 comprises optical stack 203a comprising an optical film 231, a scratch-resistant layer 233, and an optional capping layer 229. In aspects, the optical stack 203b can include the scratch resistant coating, anti-reflective coating, and/or optical film structure described in U.S. Pat. No. 9,328,016, issued May 3, 2016, U.S. Pat. No. 9,684,097, issued Jun. 20, 2017, U.S. Pat. No. 9,703,011, issued Jul. 11, 2017, U.S. Pat. No. 9,079,802, issued Jul. 14, 2015, U.S. Pat. No. 9,726,786, issued Aug. 8, 2017, U.S. Pat. No. 10,416,352, issued Sep. 17, 2019, which are incorporated by reference in their entirety. For example, the optical stack 203b can be an anti-reflective coating and/or a scratch-resistant coating.

In further aspects, as shown in FIG. 15C, the optical film 130 of the optical stack 203b can comprise one or more periods 223 comprising two or more layers with different refractive indices, for example, a first low RI layer 225 and a second high RI layer 227. For example, the optical stack 203b shown in FIG. 15C has 3 periods 223 forming the optical film 231 with alternating first low RI layers 225 and second high RI layers 227. In even further aspects, the optical film 231 can comprise any number of periods, for example, within one or more of the ranges discussed above for the optical stack 203a. An absolute value of a difference between the first low RI layers 225 and the second high RI layers 227 can be about 0.01 or more, about 0.05 or more, about 0.1 or more, or even 0.2 or more. In further aspects, the first low RI layers 225 can comprise any of the materials discussed above for the first low RI layer 215a, for example, silicon dioxide (SiO₂). In further aspects, the second high RI layers 227 can comprise any of the materials discussed above for the second high RI layer 217a, for example, SiOₓN_{y}. In further aspects, a layer of the first low RI sub-layers 225 and/or the second high RI sub-layers 227 can comprise an optical thickness (n*d) in the range from about 2 nm to about 200 nm, from about 10 nm to about 100 nm, from about 15 nm to about 100 nm, or any range or subrange therebetween. In even further aspects, all of the layers in the optical film 130 or all of the second high RI layers in the optical film 130 can have an optical thickness within one or more of the ranges mentioned in the previous sentence. In further aspects, a layer of the first low RI sub-layers 225 and/or the second high RI sub-layers 227 can comprise a physical thickness from about 10 nm to about 800 nm, from about 10 nm to about 500 nm, from about 10 nm to about 300 nm, from about 10 nm to about 200 nm, from about 20 nm to about 100 nm, or any range or subrange therebetween. In further aspects, the optical stack 203 and/or any one or of the layers or sections therein (e.g., optical film 231, a scratch-resistant layer 233, an optional capping layer 229) may exhibit an extinction coefficient (at a wavelength of about 400 nm) of about 10⁴ or less.

In further aspects, as shown in FIG. 15C, the scratch-resistant layer 233 can include an inorganic carbide, nitride, oxide, diamond-like material, or combination of these. Examples of suitable materials for the scratch-resistant layer 233 include metal oxides, metal nitrides, metal oxynitride, metal carbides, metal oxycarbides, and/or combinations thereof combination thereof. Exemplary metals include B, Al, Si, Ti, V, Cr, Y, Zr, Nb, Mo, Sn, Hf, Ta and W. Specific examples of materials that may be utilized in the scratch-resistant layer 233 may include Al₂O₃, AlN, AlOₓN_{y}, Si₃N₄, SiOₓN_{y}, Siᵤ AlᵥOₓN_{y}, diamond, diamond-like carbon, SiₓC_{y}, SiₓO_{y}C_{z}, ZrO₂, TiOₓN_{y}, or combinations thereof. In even further aspects, the scratch-resistant layer 233 can comprise the same material as the second high RI layers 227, for example, SiOₓN_{y}. In even further aspects, a physical thickness of the scratch-resistant layer and/or the optical stack can be from about 0.05 μm to about 3 μm, from about 0.1 μm to about 3 μm, from about 0.2 μm to about 3 μm, from about 0.3 μm to about 2.2 μm, from about 0.5 μm to about 2.1 μm, from about 1 μm to about 2.1 μm, from about 1.8 μm to about 2.1 μm, or any range or subrange therebetween. In exemplary aspects, a physical thickness of the scratch-resistant layer can be from 0.05 μm to 3 μm, from 0.3 μm to 2.2 μm, or from 1 μm to 2.1 μm. The scratch-resistant layer 233 and/or the optical stack 203b may exhibit a hardness of about 8 GPa or greater, about 10 GPa or greater, about 13 GPa or greater, or about 17 GPa or greater, as measured by the Berkovich Indenter Hardness Test (as described below).

Although not shown, it is to be understood that the scratch-resistant layer can be sandwiched by portions of the optical film. For example, 3 or more periods can be positioned between the scratch-resistant layer and the substrate while 2 or more periods can be positioned between the scratch-resistant layer and the surface-modifying layer (e.g., anti-fingerprint coating).

In further aspects, as shown in FIG. 15C, the optical stack 203b can comprise capping layer 229 disposed over (e.g., disposed on) the scratch-resistant layer. In even further aspects, the capping layer 229 can include a low refractive index material, such as SiO₂, Al₂O₃, GeO₂, SiO₂, AlOₓN_{y}, SiOₓN_{y}, SiᵤAlᵥOₓN_{y}, MgO, MgF₂, BaF₂, CaF₂, DyF₃, YbF₃, YF₃, or CeF₃. In further aspects, the capping layer 229 can comprise the same material as the first high RI layers 225, for example, SiO₂. In further aspects, a thickness of the capping layer 229 can be from about 10 nm to about 120 nm, from about 20 nm to about 115 nm, from about 50 nm to about 110 nm, from about 80 nm to about 110 nm, from about 90 nm to about 105 nm, or any range or subrange therebetween. The capping layer 229 may exhibit an intrinsic hardness in the range from about 7 GPa to about 10 GPa, as measured by the Berkovich Indenter Hardness Test (as measured on the surface of a layer of the same material of the capping layer, formed in the same manner, but having a thickness of about 1 micrometer or greater).

In further aspects, a stack thickness 209b corresponding to a physical thickness of the optical stack 203b can range from about 0.5 μm to about 3 μm, from about 1 μm to about 3 μm, from about 1.2 μm to about 3 μm, from about 1.5 μm to about 3 μm from about 2 μm to about 2.6 μm, or any range or subrange therebetween. In further aspects, the optical stack 203b can exhibit an average light reflectance of about 0.5% or less, about 0.25% or less, about 0.1% or less, or even 0.05% or less over the optical wavelength regime. In further aspects, the optical stack 203b can exhibit an average transmittance or average reflectance having an average oscillation amplitude of about 5 percentage points or less over the optical wavelength regime. In further aspects, the optical stack 203b may exhibit an average light transmission of 80% or greater, 82% or greater, 85% or greater, 90% or greater, 90.5% or greater, 91% or greater, 91.5% or greater, 92% or greater, 92.5% or greater, 93% or greater, 93.5% or greater, 94% or greater, 94.5% or greater, or 95% or greater.

The optical stack 203, 203a, or 203b may be formed using various deposition methods, for example, vacuum deposition techniques, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used, for example, printing, spraying, or slot coating. Where vacuum deposition is utilized, inline processes may be used to form the optical stack 203, 203a, or 203b in one deposition run. In aspects, the vacuum deposition can be made by a linear PECVD source. In aspects, the optical stack 203, 203a, or 203b can be prepared using a sputtering process (e.g., a reactive sputtering process), chemical vapor deposition (CVD) process, plasma-enhanced chemical vapor deposition process, or some combination of these processes. In aspects, the optical stack 203a or 203b comprising low RI layer(s) 215a, 215b, or 225 and high RI layer(s) 217a, 217b, or 227 can be prepared according to a reactive sputtering process. According to some embodiments, optical stack 203a or 203b (including low RI layer 215a, 215b, or 225, high RI layer 217a, 217b, or 227 and capping layer 219 or 229) can be fabricated using a metal-mode, reactive sputtering in a rotary drum coater. The reactive sputtering process conditions were defined through careful experimentation to achieve the desired combinations of hardness, refractive index, optical transparency, low color, and controlled film stress.

In one or more embodiments, the optical coating may be a gradient coating that comprises a composition gradient, causing a refractive index gradient. For example, the optical coating may include an optical stack that can comprise a gradient coating comprising a refractive index gradient. For example, the gradient coating of the optical stack can be positioned between the surface-modifying layer (e.g., anti-fingerprint coating) and the substrate 12. In even further aspects, the refractive index gradient can span a range of refractive index values of about 0.2 or more, about 0.3 or more, about 0.4 or more, about 1 or less, about 0.8 or less, about 0.6 or less, or about 0.5 or less, for example, from about 0.2 to about 1, from about 0.3 to about 0.8, from about 0.4 to about 0.6, or any range or subrange therebetween. In even further aspects, the gradient coating can comprise a concentration gradient of one or more of oxygen, nitrogen, and/or silicon. It should be understood, however, that other functional coatings may be provided in the optical stack to achieve predetermined optical properties of the article 10.

In additional embodiments, the optical coating may comprise a stack of alternating high and low refractive index layers.

In some embodiments, the optical coating is an anti-reflection coating comprising a total reflectance less than 1%, such as less than 0.8%, less than 0.6%, less than 0.4, or even 0.2%. Total reflectance, as described herein, refers to the the photopic average reflectance values exhibited as measured at an incident angle from about 5° to 20° from normal at wavelengths from 450 nm to 650 nm. As used herein, “photopic average reflectance” mimics the response of the human eye by weighting the reflectance versus wavelength spectrum according to the human eye's sensitivity. Photopic average reflectance may also be referred to as the luminance, or tristimulus Y value of reflected light, according to known conventions, for example CIE color space conventions. The photopic average reflectance (Rₚ) is defined as the spectral reflectance, R(λ) multiplied by the illuminant spectrum, I(λ), and the CIE's color matching function, y̅(λ), related to the eye's spectral response:

$$( {R}_{p} ) = {\int }_{380 nm}^{720 nm} R ( λ ) \times I ( λ ) \times \overline{y} ( λ ) d λ .$$

According to one or more embodiments, the article including at least the optical coating exhibits a hardness greater than 8 GPa, as measured by a Berkovich Indenter Hardness test. For example, the optical coating may exhibit hardes of at least 10 GPa, at least 12 GPa, at least 15 GPa, or even at least 20 GPa.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of an outer layered film of a cover article of the disclosure with the diamond Berkovich indenter to form an indent to an indentation depth in the range from about 50 nm to about 1000 nm (or the entire thickness of the outer layered film, whichever is less) and measuring the maximum hardness from this indentation along the entire indentation depth range or a segment of this indentation depth (e.g., in the range from about 100 nm to about 600 nm, from about 100 nm to about 500 nm, to a depth of 200 nm, etc.), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

Typically, in nanoindentation measurement methods (such as the Berkovich Indenter Hardness Test) of a coating or film that is harder than the underlying substrate, the measured hardness may appear to increase initially due to development of the plastic zone at shallow indentation depths and then increases and reaches a maximum value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate. The indentation depth range and the hardness values at certain indentation depth range(s) can be selected to identify a particular hardness response of the outer layered films and layers thereof, described herein, without the effect of the underlying substrate.

When measuring hardness of the outer layered film of the cover articles of the disclosure according to the Berkovich Indenter Hardness Test, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate. The substrate influence on hardness occurs at deeper indentation depths (i.e., typically at depths greater than about 10% of the outer layered film or layer thickness). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm) in the outer layered film of the cover articles of the disclosure, the apparent hardness of a material appears to increase dramatically versus indentation depth. This small indentation depth regime does not represent a true metric of hardness, but instead reflects the development of the aforementioned plastic zone, which is related to the finite radius of curvature of the indenter. At intermediate indentation depths, the apparent hardness approaches maximum levels. At deeper indentation depths, the influence of the substrate (e.g., substrate 12, as described in detail below) becomes more pronounced as the indentation depths increase. Hardness may begin to drop dramatically once the indentation depth exceeds about 30% of the outer layered film of the cover articles of the disclosure.

The optical coating may vary in thickness, for example being greater than 200 nm such as greater than or equal to about 250 nm, 300 nm, 325 nm, 350 nm, 375 nm, 400 nm, 425 nm, 450 nm, 475 nm, 500 nm, 525 nm, 550 nm, 575 nm, 600 nm, 700 nm, 800 nm, 900 nm, 1 micron, 2 microns, 3 microns, 4 microns, 5 microns, 6 microns, 7 microns, or even 8 microns. Increased thickness may promote scratch protection, but may hinder other optical properties like transmittance.

According to one or more embodiments, the article comprising a surface-modifying layer (not depicted in FIG. 2) disposed on the primary surface 18, wherein the surface-modifying layer is one of an anti-smudge or easy-to-clean coating layer. Throughout the disclosure, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping).

In aspects, the surface-modifying layer can be an anti-fingerprint coating. Throughout the disclosure, a surface-modifying layer is an “anti-smudge” or “anti-fingerprint” coating if the coating on a glass-based substrate can reduce the visibility of, reduce a color shift of, and/or reduce droplet formation of fingerprint oil disposed thereon relative to the glass-based substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the glass-based substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 750 or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be about 450 or less, about 40° or less, about 30° or less, about 25° or less, about 20° or less, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the anti-fingerprint coating rather than beading up into pronounced droplets.

In additional aspects, the surface-modifying layer can be an easy-to-clean coating. Throughout the disclosure, a surface-modifying layer is an “easy-to-clean” coating if the coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from 900 to 120°, an (e.g., as-formed) oleic acid contact angle of 50° or more, and a coefficient of friction of 0.25 or less. In further aspects, the easy-to-clean coating can be a fluorine-containing material. Alternatively, in further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, the an anti-fingerprint coating can be oleophilic. In aspects, a hexadecane contact angle of the an anti-fingerprint coating (e.g., as-formed) can be about 45° or less, about 40° or less, about 30° or less, about 25° or less, about 20° or less, or the an anti-fingerprint coating can wet hexadecane. In further aspects, the an anti-fingerprint coating (e.g., as formed) wets hexadecane. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the surface-modifying layer rather than beading up into pronounced droplets.

In some embodiments, the article 10 may comprise an anti-reflective coating such as a alterning refractive index stack and/or a gradient coating positioned between the surface-modifying layer and the primary surface.

### Examples

In order that various embodiments be more readily understood, reference is made to the following examples, which are intended to illustrate various embodiments of the textured, antiglare articles described herein.

Table 1 lists the components (in mol %) of Example Compositions C1 and C2. C1 used a sheet of Gorilla® Glass Victus® produced by Corning® Incorporated with a composition as specified below in Table 1. For more details about C1 reference is made to co-assigned U.S. Pat. No. 11,584,681 the contents of which are incorporated herein by reference. C2 a sheet of Gorilla® Glass Victus®2 produced by Corning® Incorporated with a composition as specified below in Table 1. For more details about C2 reference is made to co-assigned U.S. Patent Publication US 2023/0107789, the contents of which are incorporated herein by reference.

TABLE 1

| Examples | C1 | C2 |
|---|---|---|
| SiO₂ | 59.09 | 64.90 |
| Al₂O₃ | 17.94 | 15.53 |
| P₂O₅ | 0.66 | 0.86 |
| B₂O₃ | 4.08 | 3.21 |
| Li₂O | 8.00 | 7.20 |
| Na₂O | 8.79 | 4.78 |
| K₂O | 0.08 | 0.21 |
| MgO | 1.23 | 0.54 |
| ZnO | 0.01 | — |
| CaO | 0.02 | — |
| TiO2 | 0.10 | 0.18 |
| CaO | — | 1.47 |
| Fe₂O₃ | — | 0.02 |
| ZrO₂ | — | 0.01 |
| SnO₂ | 0.04 | 0.04 |
| SrO | — | 1.07 |

Table 2 lists the optical properties of Example Articles A1-A8 formed from Example Compositions C1 and C2, as indicated Table 2. The Example Articles A1-A3 were tested for a variety of optical properties and physical features, listed in Table 2 and described hereinbelow. The texturing was produced by the lithographic methods described herein.

TABLE 2

| Example | A1 | A2 | A3 | A4 | A5 | A6 | A7 | A8 |
|---|---|---|---|---|---|---|---|---|
| Composition | C2 | C2 | C1 | C1 | C2 | C2 | C1 | C1 |
| Absolute specular reflectance (%) | 0.2 | 0.2 | 0.2 | 0.2 | 0.2 | 0.2 | 0.2 | 0.2 |
| Transmittance haze (%) | 22.2 | 22.3 | 23.3 | 23.1 | 26.8 | 26 | 30.4 | 31 |
| Sparkle (%) | 2.7 | 2.8 | 3.29 | 3.06 | 2.59 | 2.59 | 2.65 | 2.51 |
| uDOI (%) | 6.16 | 6.97 | 2.14 | 4.41 | 2.34 | 2.21 | 1.07 | 3.09 |
| 20x Overall Sa (um) | 0.276 | | 0.318 | | 0.301 | | 0.403 | |
| 20x High Freq features Sa (um) | 0.247 | | 0.260 | | 0.264 | | 0.294 | |
| 20x Low Freq Features Sa (um) | 0.085 | | 0.128 | | 0.103 | | 0.215 | |
| 20x Overall Pz (um) | 1.374 | | 1.518 | | 1.484 | | 1.839 | |
| 20x High Freq features Pz (um) | 1.200 | | 1.246 | | 1.269 | | 1.402 | |
| 20x Low Freq Features Pz (um) | 0.269 | | 0.397 | | 0.329 | | 0.615 | |
| 20x Overall SAL (um) | 9.168 | | 11.107 | | 9.494 | | 15.577 | |
| 20x High freq features SAL (um) | 7.759 | | 8.214 | | 7.769 | | 8.585 | |
| 20x Low Freq Features SAL (um) | 28.714 | | 33.782 | | 29.993 | | 42.786 | |
| 20x Overall Psm (um) | 35.043 | | 43.591 | | 37.068 | | 49.444 | |
| 20x High freq features Psm (um) | 31.234 | | 33.104 | | 31.079 | | 33.294 | |
| 20x Low Freq Features Psm (um) | 155.058 | | 132.634 | | 127.448 | | 166.358 | |
| 50x Overall Sa (um) | 0.281 | | 0.316 | | 0.315 | | 0.379 | |
| 50x High Freq feaures Sa (um) | 0.249 | | 0.259 | | 0.274 | | 0.282 | |
| 50x Low Freq Feaures Sa (um) | 0.082 | | 0.116 | | 0.104 | | 0.205 | |
| 50x Overall Pz (um) | 1.052 | | 1.135 | | 1.131 | | 1.260 | |
| 50x High Freq feaures Pz (um) | 0.881 | | 0.929 | | 0.971 | | 1.046 | |
| 50x Low Freq Feaures Pz (um) | 0.158 | | 0.238 | | 0.251 | | 0.360 | |
| 50x Overall SAL (um) | 8.889 | | 10.510 | | 9.556 | | 14.109 | |
| 50x High freq features SAL (um) | 7.556 | | 8.213 | | 7.826 | | 8.177 | |
| 50x Low Freq Features SAL (um) | 26.986 | | 24.476 | | 24.734 | | 38.683 | |
| 50x Overall Psm (um) | 35.078 | | 40.594 | | 37.481 | | 43.133 | |
| 50x High freq features Psm (um) | 30.515 | | 32.369 | | 30.986 | | 32.027 | |
| 50x Low Freq Features Psm (um) | 94.354 | | 99.266 | | 106.637 | | 124.009 | |
| Transmittance (%) | 92.9 | 92.9 | 92.7 | 92.9 | 92.9 | 92.8 | 92.8 | 92.8 |
| uGLOSS20 (GU) | 11.13 | 11.24 | 10.4 | 10.44 | 9.53 | 9.78 | 8.46 | 8.23 |
| uGLOSS60 (GU) | 25.96 | 26.31 | 25.59 | 25.68 | 23.46 | 24.05 | 22.27 | 21.95 |
| uGLOSS85 (GU) | 66.13 | 66.54 | 61.93 | 63.47 | 60.75 | 61.5 | 54.01 | 54.82 |
| uRHAZE (%) | 24.1 | 24.37 | 23.29 | 23.36 | 21.51 | 22.02 | 19.9 | 19.5 |
| uLogRHAZE | 441.21 | 444.71 | 430.88 | 431.84 | 407.42 | 414.38 | 385.41 | 379.74 |
| uRspec (%) | 1.89 | 1.93 | 1.75 | 1.79 | 1.59 | 1.64 | 1.44 | 1.44 |
| cGLOSS20 (GU) | 0.53 | 0.52 | 0.35 | 0.32 | 0.29 | 0.3 | 0.13 | 0.07 |
| cGLOSS60 (GU) | 13.41 | 13.61 | 13.27 | 13.33 | 11.74 | 12.15 | 11.27 | 10.96 |
| cGLOSS85 (GU) | 65.66 | 66.03 | 61.19 | 62.91 | 60.03 | 60.96 | 53.78 | 54.15 |
| cRHAZE (%) | 2.79 | 2.84 | 2.73 | 2.74 | 2.35 | 2.42 | 2.3 | 2.25 |
| cLogRHAZE | 72.93 | 74.06 | 71.29 | 71.53 | 61.95 | 63.8 | 60.66 | 59.47 |
| cDOI (%) | 0 | 0 | 0 | 0 | 0 | 0 | 0 | 0 |
| cRspec (%) | 0.2 | 0.21 | 0.2 | 0.22 | 0.18 | 0.18 | 0.18 | 0.17 |

| Ring location (deg) Cx ring | 0 | 0 | 0 | 0 |
|---|---|---|---|---|
| Ring location (deg) Cy ring | 0 | 0 | 0 | 0 |
| Color shift DCx | 0 | 0 | 0 | 0 |
| Color shift DCy | 0 | 0 | 0 | 0 |
| Corrected color shift DCx_c | 0 | 0 | 0 | 0 |
| Corrected color shift DCy_c | 0 | 0 | 0 | 0 |
| 2 surface Rx 6° (%) | 1.05 | N/A | 0.95 | N/A |
| Washout MTF | 0.54 | N/A | 0.42 | N/A |
| Dark-room MTF | 0.95 | N/A | 0.95 | N/A |
| 1st surface Rx 6° (450-650 Avg.) (%) | 0.1 | N/A | 0.094 | N/A |
| 1st surface Rx 20° (450-650 Avg.) (%) | 0.11 | N/A | 0.097 | N/A |
| 1st surface Rx 45° (450-650 Avg.) (%) | 0.17 | N/A | 0.16 | N/A |
| 1st surface Rx 60° (450-650 Avg.) (%) | 0.44 | N/A | 0.38 | N/A |
| Rx L* 6° | 0.94 | N/A | 0.85 | N/A |
| Rx a* 6° | 0.08 | N/A | 0.03 | N/A |
| Rx b* 6° | −0.23 | N/A | −0.22 | N/A |
| Tx (450-650 Avg) (%) | 90.63 | N/A | 90.5 | N/A |
| Tx L* | 96.26 | N/A | 96.21 | N/A |
| Tx a* | −0.03 | N/A | −0.03 | N/A |
| Tx b* | 0.22 | N/A | 0.23 | N/A |

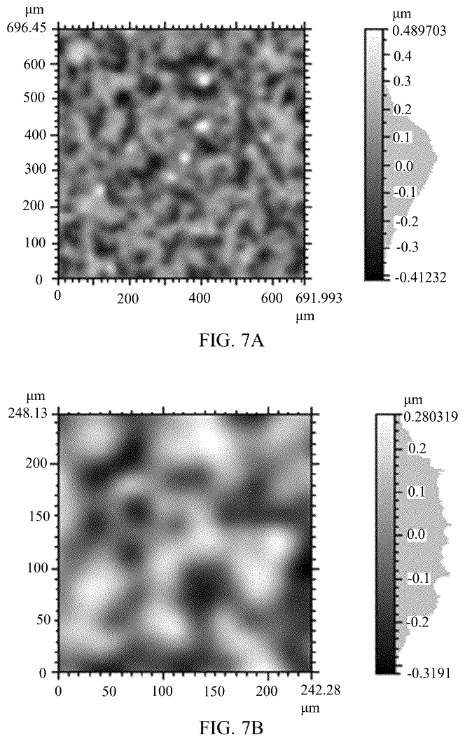

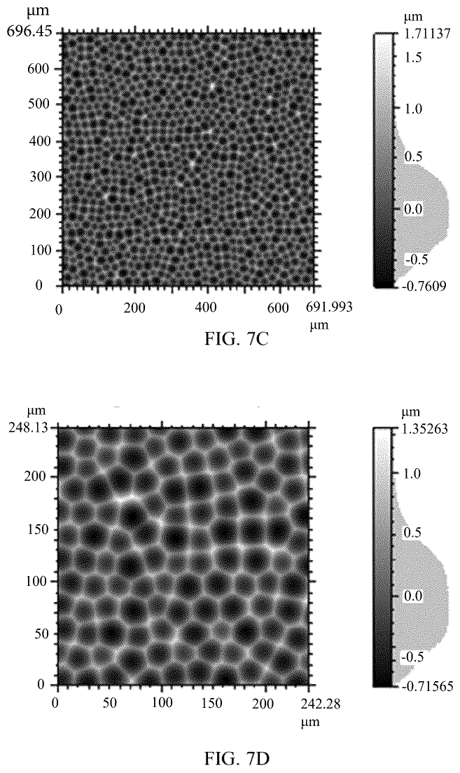

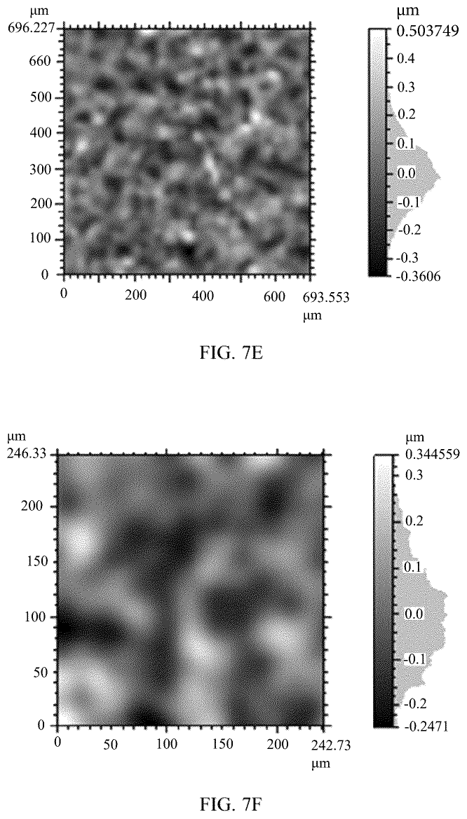

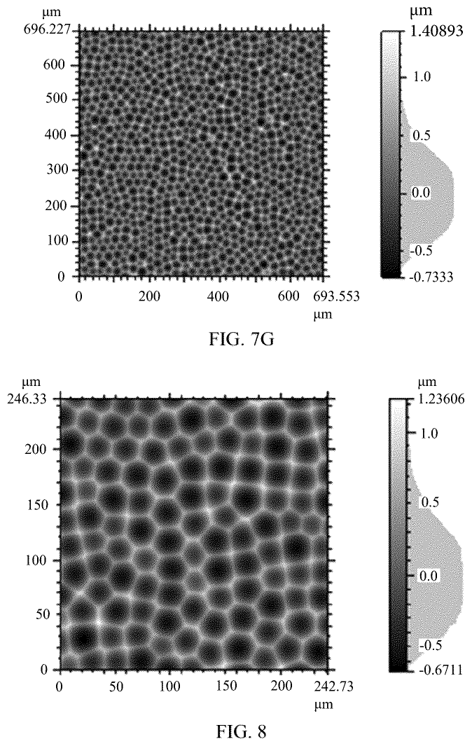

To separate high and low spatial frequency sub-regions, Example Articles A5/A6 and A1/A2 had a 60 um (about 0.0167/micron frequency, proving a general cut-off between the random and ordered parts) Gaussian filter applied according to ISO 16610-61 in MountainsMap Software on surface data measured using a Zygo NewView 9000 interferometer using a 20× and 50× objective. Referring now to FIGS. 7A and 7B, 20× and 50× images, respectively, of the low spatial frequency sub-region of Example Article A5/A6 are shown. Referring now to FIGS. 7C and 7D, 20× and 50×, respectively of the high spatial frequency sub-region of Example Article A5/A6 are shown. Referring now to FIGS. 7E and 7F, 20× and 50× images, respectively, of the low spatial frequency sub-region of Example Article A1/A2 are shown. Referring now to FIGS. 7G and 8, 20× and 50×, respectively of the high spatial frequency sub-region of Example Article A1/A2 are shown.

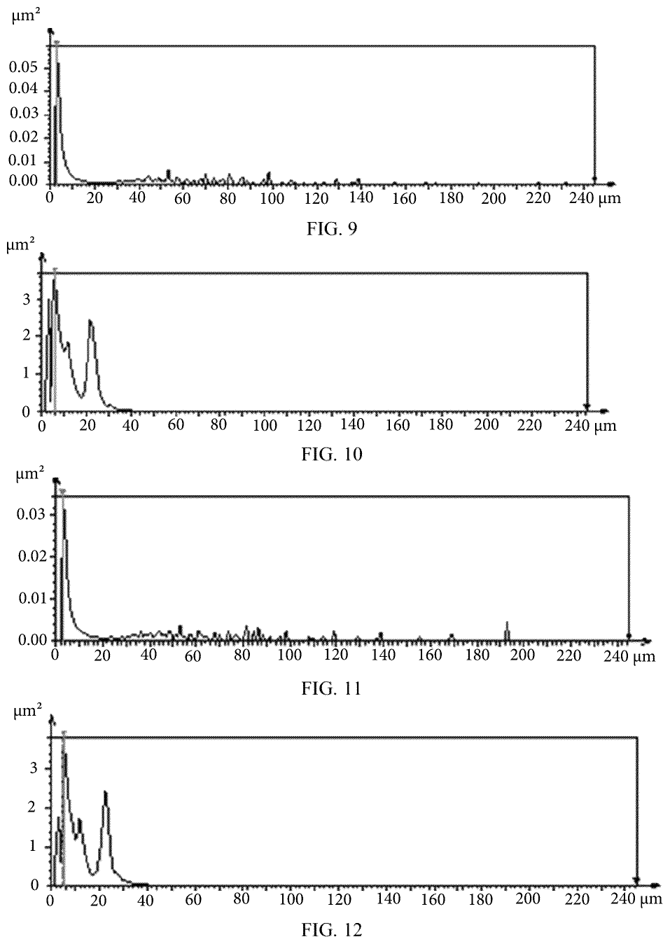

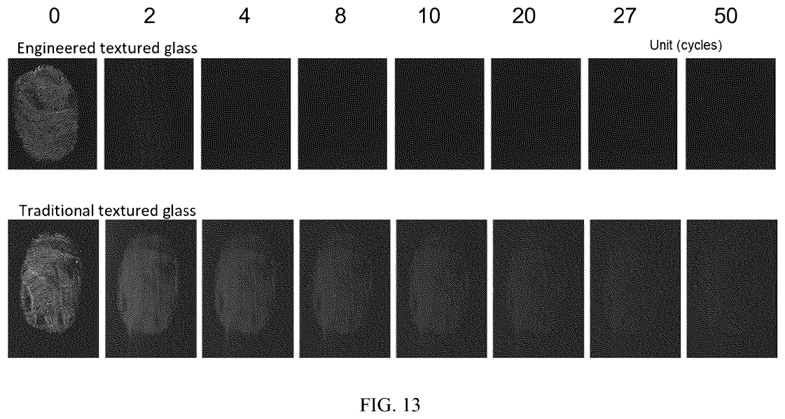

Referring now to FIGS. 9-12, the averaged power spectal density plots using the 20× objective of the low spatial frequency sub-region and the high-spatial frequency sub-region of Example Articles A5/A6 and A1/A2, respectively, are shown.

In the examples, reflectance and transmittance values are reported as polarization averages, that is, average values combining both s- and p-polarization values into a single average. Photopic averages (Y), L*, a*, and b* values were calculated from measured sample data using known methods according to the CIE 1964 standards with 10° observer and D65 illuminant. These create weighted values according to the human eye's response to visible light. Specular reflectance was measured in an angular range of +/−1 degrees using an Agilent Cary 5000 UV-Vis-NIR spectrophotometer. 1st-surface reflectance values were obtained by using an index matching oil to couple the back surface of the glass sample to a light absorber.

Transmitted haze was measured by a BYK Gardner Haze-Gard. Uncoupled (2-surface) DOI was measured using a Rhopoint IQ 20/60/85 Gloss Haze DOI Meter (Rhopoint Americas Inc.). The coupled DOI was estimated from the uncoupled DOI values using a relation derived from historical data. Total transmittance was measured using a Perkin-Elmer Lambda 950 spectrophotometer.

As described herein, the contrast ratio (CR) of a display for white can be defined by following equation:

$$C R = ( \frac{{L}_{white screen +} {L}_{a m bient light}}{{L}_{black screen} + {L}_{a m bient light}} )$$

Where L_{white screen} and L_{black screen} are luminance of white and black screen, respectively and L_{ambient light} is luminance of reflected ambient light from the display. According to this definition the highest CR can be found in the absence of the external (ambient) light. In the work CR ratio and color gamut are of the display with relevant cover glass was measured under two different illumination conditions as follow: a) Ambient CR (ACR): CR measurement under uniform diffused (omnidirectional) D65 white light illumination; and b) Direct CR (DCR): CR measurement under a directional/collimated white light illumination.

As described herein, ambient contrast ratio (“ARC” or simply “RC”) may be measured. The CR measurement was performed by following NISTIR 6738, a method/procedure to measured CR of display, developed by National Institute of Standards and Technologies. The measurement was performed by coupling untreated side of the test (glass) sample on to an OLED display with index matching oil. Instrument Systems's CAS140D spectroradiometer equipped with TOP 200 optical probe was used to measure the photopic luminance from the sample/display unit.

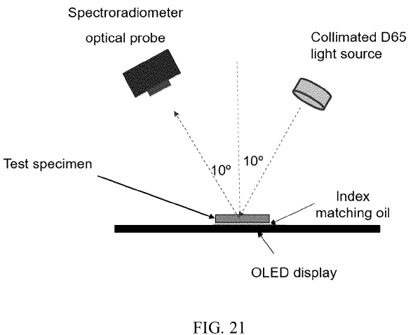

Additionally, the direct contrast ratio (“DCR”) may be measured. In DCR measurement a collimated (D65) LED light source was used as the illumination source. As depicted in FIG. 21, Angle of Incident (AOI) of the light was set to 10° while luminance of the display and the external light source detected by placing a spectroradiometer at the specular direction (at −10°). Intensity of the external light source was control through by controlling the current to the current to the LED source and/or by placing appropriate neutral density (ND) filter in the optical path. Prior to the (DCR) measurement the light illuminance intensity (in lux) for each illumination condition was measured by replacing the test specimen with an illuminance meter (model A58U-223 from Konica Minolta). Similar to ACR setup CAS140D spectroradiometer equipped with TOP 200 optical probe (Instrument Systems) was used to measure the photopic luminance from the sample/display unit. Collection (cone) angle of the in the TOP200 was set to 1 degree. Photopic luminance of the display, while it is coupled with the test specimen, was measured while the display was loaded with black and white images, respectively. The contrast was calculated by dividing luminance of the white screen by that of black screen. The same procedure was followed at various different illuminance intensities by illumination the test specimen using the calibrated light source source/ND filter setup.

Additionally, color gamut area (CGA) can be measured. Besides CR, the performance color under external illumination may be an important property of a display. The color performance can be defined as the range of colors that a particular display device produces. The color information for a given display can be represented by specifying chromaticity coordinates for RGB in the CIE 1976 color space diagram. The area inside the triangle is proportional to the available colors for a given display illumination condition. The total area of the CIE 1976 diagram represents the full range of colors visible to the human eye. Hence the available colors for a given display can be assessed by measuring the area of the triangle in the color space. Considering this principle, measurement color gamut area of the display under variable illuminance was performed. The area of the color gamut (CGA) can be obtained by measuring the chromaticity coordinate in the color space (CIE 1976 (u′,v′)) for red (u′_{R}, v′_{R}), green (u′_{G}, v′_{G}) and blue (u′_{B}, v′_{B}) colors under variable illuminance intensities. Here CGA can be calculated by measuring CIE (u′, v′) coordinates of the RGB color triangle for the display with coupled test specimen while it is lit red, green and blue images. The area of the RGB triangle (CGA) is proportional to the number of colors emitted through the display/test specimen unit. The area of the triangle was measured by using the Herons formula:

$$C G A = \frac{1}{4} \sqrt{{( {a}^{2} + {b}^{2} + {c}^{2} )}^{2} - 2 ( {a}^{4} + {b}^{4} + {c}^{4} )}$$

where a, b and c are found from following equations:

$$a = \sqrt{{( {v}_{R}^{′} - {v}_{B}^{′} )}^{2} + {( {u}_{R}^{′} - {u}_{B}^{′} )}^{2}}$$

$$b = \sqrt{{( {v}_{R}^{′} - {v}_{G}^{′} )}^{2} + {( {u}_{R}^{′} - {u}_{G}^{′} )}^{2}}$$

$$c = \sqrt{{( {v}_{B}^{′} - {v}_{G}^{′} )}^{2} + {( {u}_{B}^{′} - {u}_{G}^{′} )}^{2}}$$

The same procedure was applied to measure the CGA under various illumination intensities and illumination conditions. CGA under diffused illumination was performed by using the calibrated integrating sphere setup where as DCR setup was used to measure CGA under direct/collimated illumination. The largest CGA can be found in the absence of external illumination. Therefore, for better understanding, CGA at any given illuminance, is presented as a percentage with respect to its original value without any external illuminance.

As described in the Examples, Sa is the arithmetic mean height calculated on the zygo 20× or 50× surface data per ISO 25178 in MountainsMap software. The average value of all the Pz values measured on every horizontal profile of the zygo 20× or 50× surface data per ISO 21920 in MountainsMap software. Pz is the maximum height (peak-to-valley) within a section length on a horizontal profile across the surface per ISO 21920. SAL is the autocorrelation length calculated on the zygo 20× or 50× surface data per ISO 25178 in MountainsMap software. Psm is the mean width of the profile measurements per ISO 21920, and in this case is the average value of all the Psm values measured on every horizontal profile of the zygo 20× or 50× surface data per ISO 21920 in MountainsMap software. High frequency features were calculated on Zygo 20× and 50× surface data from Zygo with no Filters applied. Low frequency features were calculated on the low frequency waviness portion of the Zygo 20× and 50× surface data after the 60 um Gaussian filter was applied via ISO 16610

Other properties measured are reported consistent with the measurement techniques disclosed in the detailed description, such as haze, color separation, and DOI.

A fingerprint cleanability test was conducted to evaluate the ease for an end user to clean off a simulated fingerprint left on an Example Article during everyday use. Artificial sebum from Pickering Laboratories confirming to ASTM D4265-14 was used as a substitute for human oil. A rubber thumb print was used to transfer sebum to the article surface under an applied force of 500 g. A 1 kg vertically applied force was used when wiping back and forth with a microfiber cloth to clean off the simulated fingerprint. Wiping was stopped at certain intervals to inspect the presence of the fingerprint. Referring now to FIG. 13, a light scattering imaging technique utilizing a high intensity ring-light (10,000 lux) and a digital camera was employed to capture the visibility of the simulated fingerprint as a function of wiping cycles. The cleanability was determined based on the number of wiping cycles to fully remove the simulated fingerprint. To clean off the fingerprint, the Example Article required only 2 to 4 cycles, while a Comparatice Article prepared by sand blast and etch required up to 27 to 50 cycles to clean off.

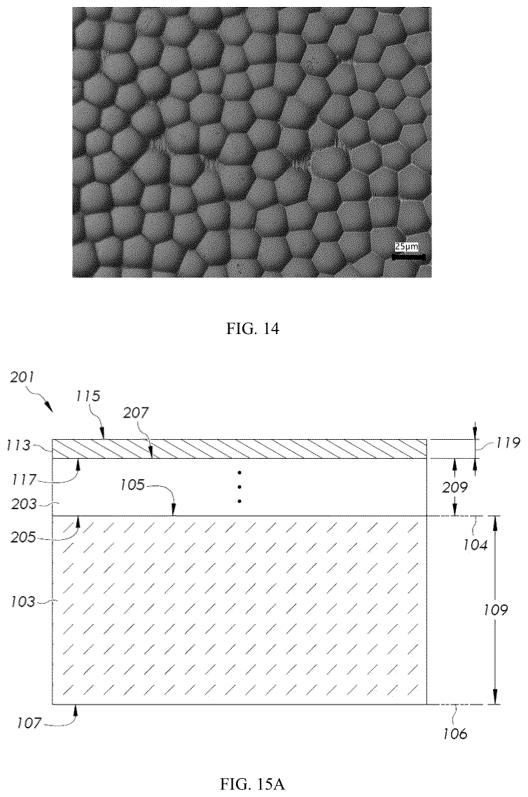

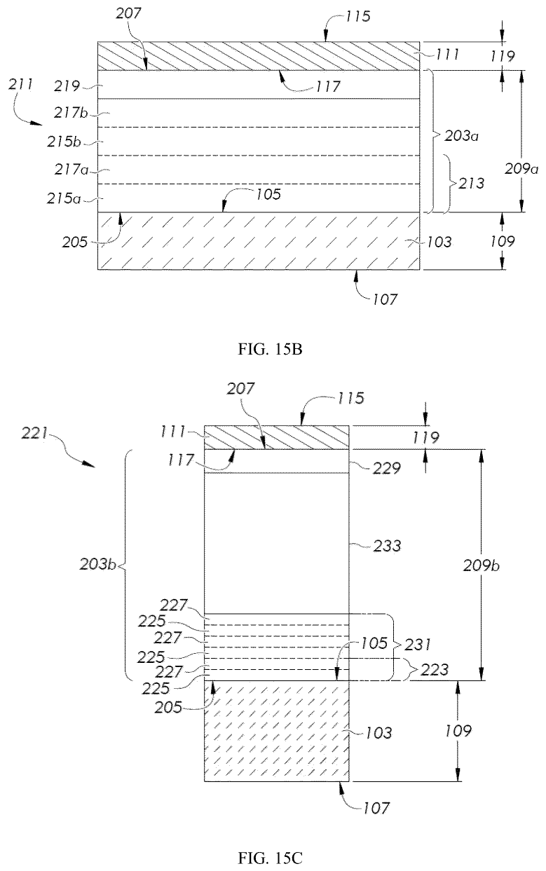

A surface durability text of an Example Article was conducted using CS8 abradant produced by Taber Industry. Abrasian was conducted on the Example Article with an applied load of 260 g. The abrasion strok length was 25 mm and the cycle speed was 60 cycles/min. Referring now to FIG. 14, the textured region of the Example Article limited the damage to a number of damage sites instead of across the entire surface, thereby limiting damage visibility.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. An antiglare article comprising:
a substrate comprising a thickness and a primary surface, the primary surface having on at least a portion thereon a textured region, wherein the antiglare article exhibits:
a first-surface absolute specular reflectance of less than or equal to 0.2% at an incident angle 6° from normal;
a transmittance haze of less than 35% at an incident angle of 0° from normal;
a sparkle of less than 3% at an incident angle of 0° from normal on a 140 PPI device;
a distinctness of image of less than 35% at an incident angle of 20° from normal; and
a color separation of less than 0.6.

2. The antiglare article of claim 1, wherein the textured region comprises:
a low spatial frequency sub-region and a high spatial frequency sub-region substantially superimposed within the low spatial frequency sub-region.

3. The antiglare article of claim 2, wherein the high spatial frequency sub-region comprises an ordered pattern.

4. The antiglare article of claim 2, wherein the high spatial frequency sub-region comprises concave features.

5. The antiglare article of claim 4, wherein each of the concave features comprises a hexagonal perimeter parallel to a base-plane extending through the substrate disposed below the texture region.

6. The antiglare article of claim 2, wherein the high spatial frequency sub-region has a period from 10 micron to 30 micron, a surface roughness (Sₐ) greater than or equal to 100 nm and less than or equal to 400 nm, and feature sizes from 10 μm to 30 μm.

7. The antiglare article of claim 2, wherein the low spatial frequency sub-region comprises a random distribution.

8. The antiglare article of claim 2, wherein the low spatial frequency sub-region has a period greater than or equal to 30 μm and less than or equal to 300 μm, a surface roughness greater than or equal to 50 nm and less than or equal to 300 nm, and feature sizes from 100 microns to 300 micron.

9. The antiglare article of claim 1, wherein the textured region comprises a surface roughness greater than or equal to 200 nm and less than or equal to 500 nm.

10. The antiglare article of claim 1, wherein the textured region comprises a peak to valley greater than or equal to 1000 nm and less than or equal to 2000 nm.

11. The antiglare article of claim 1, wherein:
the transmittance haze is greater than or equal to 10% and less than 35%,
the sparkle is greater than or equal to 1.5% and less than or equal to 3.5% at an incident angle of 0° from normal on a 140 PPI device, and
the distinctness of image is greater than or equal to 0% and less than or equal to 30% at an incident angle of 20° from normal.

12. The antiglare article of claim 1, wherein the substrate comprises a glass substrate, a glass-ceramic substrate, or a ceramic substrate.

13. The antiglare article of claim 1, wherein the substrate comprises composition comprising:
greater than or equal to 50 mol % and less than or equal to 70 mol % SiO₂;
greater than or equal to 10 mol % and less than or equal to 20 mol % Al₂O₃;
greater than or equal to 0 mol % and less than or equal to 2 mol % P₂O₅;
greater than or equal to 1 mol % and less than or equal to 6 mol % B₂O₃;
greater than or equal to 5 mol % and less than or equal to 10 mol % Li₂O;
greater than or equal to 1 mol % and less than or equal to 10 mol % Na₂O; and
greater than or equal to 0.01 mol % and less than or equal to 1 mol % K₂O.

14. The antiglare article of claim 1, wherein the substrate is an ion-exchanged substrate which comprises a surface compressive stress (CS) greater than or equal to 250 MPa, and a depth of compression (DOC) greater than or equal to 0.1 μm.

15. The antiglare article of claim 1, further comprising an optical coating disposed on the primary surface, wherein the optical coating is an anti-reflection coating comprising a total reflectance less than 1%.

16. The antiglare article of claim 15, wherein the antiglare article including the optical coating exhibits a hardness of greater than 8 GPa, as measured by a Berkovich Indenter Hardness test.

17. The antiglare article of claim 1, further comprising an optical coating disposed on the primary surface, wherein the optical coating is a gradient coating.

18. The antiglare article of claim 1, further comprising a surface-modifying layer disposed on the primary surface, wherein the surface-modifying layer is one of an anti-smudge or easy-to-clean coating layer.

19. A display device comprising the antiglare article of claim 1, wherein the antiglare article serves as a protective cover for the display device.

20. A display article comprising:
a substrate comprising a thickness and a primary surface, the primary surface having on at least a portion thereon a textured region, the texture region comprising a high spatial frequency sub-region having a period:
$$period = λ / ( Sin [ Arc Tan ( Psp / t ) ] * n )$$
with an allowable variation of 8 μm or 60%, where t is a thickness of the substrate, n is an average refractive index of the substrate, Psp is a subpixel period, and λ is a pixel light wavelength.
